(19) United States
(12) Patent Application Publication
(10) Pub. No.: US 2023/0393325 A1
(43) Pub. Date: Dec. 7, 2023

(54) METAL OXIDE FILMS AND UV-CURABLE PRECURSOR SOLUTIONS FOR DEPOSITION OF METAL OXIDE FILMS

(71) Applicant: Phosio Corporation, Corvallis, OR (US)

(72) Inventors: Omid Sadeghi, Corvallis, OR (US); Cory K Perkins, Salem, OR (US); Douglas A Keszler, Corvallis, OR (US)

(21) Appl. No.: 18/327,766

(22) Filed: Jun. 1, 2023

Related U.S. Application Data
(60) Provisional application No. 63/347,956, filed on Jun. 1, 2022.
(60) Provisional application No. 63/434,016, filed on Dec. 20, 2022.

(51) Int. Cl. F21V 8/00; G02B 1/12

(52) U.S. Cl. CPC G02B 6/0038; G02B 6/0065; G02B 1/12

(57) ABSTRACT

Examples are disclosed that relate to acid-stabilized precursor solutions for metal oxide film deposition, and to films deposited using the disclosed acid-stabilized precursor solutions. One disclosed example provides an aqueous precursor solution for forming a metal oxide film by liquid-phase deposition, the precursor solution comprising metal ions, a photolyzable and/or pyrolyzable ligand, and an acid. Another example provides a method of forming a metal oxide film, the method comprising coating a substrate with an aqueous precursor solution comprising metal ions, a photolyzable and/or pyrolyzable ligand, and an acid to form a film, and curing the film. Examples also are disclosed that relate to methods of fabricating optical waveguides using solution-based deposition of metal oxide films, followed by patterning. Examples are also disclosed that relate to optical waveguides fabricated according to the disclosed methods.

### CROSS-REFERENCE TO RELATED APPLICATIONS

This application claims priority to U.S. Provisional Patent Application Ser. No. 63/347,956, filed Jun. 1, 2022 and titled TITANIUM-CONTAINING OXIDE FILMS AND PRECURSOR SOLUTIONS FOR DEPOSITION OF TITANIUM-CONTAINING OXIDE FILMS, and to U.S. Provisional Patent Application Serial No. and 63/434,016, filed Dec. 20, 2022 and titled OPTICAL WAVEGUIDE FABRICATION USING SOLUTION-BASED METAL OXIDE FILMS. The entire discloses of both of these provisional patent applications are hereby incorporated by reference in their entireties.

### BACKGROUND

Transparent metal oxide films have revolutionized the field of materials science with their unique optical and electrical properties and have found significant use in areas such as optoelectronics, energy generation, sensors, and catalysis. For example, Group IV oxides (TiO₂, ZrO₂, and HfO₂) are commonly used as optical materials. This use is due at least in part to the relatively high refractive index and low optical absorption coefficient across the visible spectrum. These oxide films may be formed by gas-phase methods such as chemical vapor deposition (CVD), atomic layer deposition (ALD), and sputtering, which are performed in vacuum chambers. Liquid-phase deposition of these thin films have been performed using sol-gel processes utilizing precursors comprising, for example, metal cations coordinated with alkoxide ligands. Such films may require a high temperature cure to achieve a high density and remove organic species from the resulting film which limits their manufacturability using low cost, high throughput, and high resolution methods like Nanoimprint lithography (NIL). Furthermore, films produced by performing sol-gel processes have non-uniformities and/or rough surfaces that can preclude such films from having high-resolution and/or high-fidelity patterns.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

One disclosed example provides an aqueous precursor solution for forming a metal oxide film by liquid-phase deposition, the precursor solution comprising metal ions, a photolyzable and/or pyrolyzable ligand, and an acid. Another example provides a method of forming a metal oxide film, the method comprising coating a substrate with an aqueous precursor solution comprising metal ions, a photolyzable and/or pyrolyzable ligand, and an acid to form a film, and curing the film.

Examples also are disclosed that relate to methods of fabricating optical waveguides using solution-based deposition of metal oxide films, followed by patterning. Examples further are disclosed that relate to optical waveguides fabricated according to the disclosed methods.

### BRIEF DESCRIPTION OF THE FIGURES

FIG. 1A shows a graph depicting experimentally determined refractive indices and absorption coefficients for TiO₂ films deposited using an example precursor solution.

FIG. 1B shows a graph depicting experimentally determined refractive indices and absorption coefficients for TiO₂ films deposited using the example precursor solution of FIG. 1A, and after UV curing.

FIG. 1C shows a graph depicting experimentally determined refractive indices and absorption coefficients for TiO₂ films deposited using the example precursor solution of FIG. 1A, and after UV curing plus annealing at 250 degrees Celsius.

FIG. 1D shows a graph depicting experimentally determined refractive indices and absorption coefficients for TiO₂ films deposited using the example precursor solution of FIG. 1A, and after UV curing plus annealing at 600 degrees Celsius.

FIGS. 2A-2B show experimental data illustrating scanning electron microscope (SEM) images of an example imprinted TiO₂ film and an example blanket TiO₂ film.

FIG. 2C shows a graph illustrating optical transmission data for an ultraviolet light-cured (UV-cured) TiO₂ film.

FIG. 2D shows x-ray diffraction (XRD) data for example UV-cured TiO₂ films processed with different annealing conditions.

FIGS. 3A-3B show experimental data illustrating SEM images for an example imprinted Ti/Al oxide film.

FIG. 3C shows a graph of refractive indices and optical absorption coefficients for example Ti/Al oxide films as a function of wavelength.

FIG. 3D shows X-ray diffraction data for example AlₓTi_{y}Oₙ films that have been UV-cured and annealed at different temperatures.

FIG. 4 shows a graph of refractive indices and optical absorption coefficients for an example Ti/Nb oxide film as a function of wavelength.

FIG. 5 shows a graph of refractive index and optical absorption coefficient for example TiO₂/TiO₂ nanoparticle composite films as a function of wavelength.

FIGS. 6A-6B show an example method of fabricating an optical waveguide comprising a patterned high-index metal oxide film using an acid-stabilized liquid phase precursor solution.

FIG. 7 shows an image of an example pattern formed in an optical waveguide fabricated according to the methods described in the present disclosure.

FIG. 8 shows a scanning electron microscope (SEM) image of an example pattern formed in an optical waveguide fabricated according to the methods described in the present disclosure.

FIG. 9 shows an example optical image of a scene transmitted through a patterned optical waveguide fabricated according to the methods described in the present disclosure.

FIG. 10A shows a graph of refractive index and optical absorption coefficient for an example uncured zirconium oxide (ZrO₂) film deposited using an acid-stabilized liquid phase precursor solution.

FIG. 10B shows a graph of refractive index and optical absorption coefficient for the ZrO₂ film of FIG. 10A after performing UV light curing.

FIG. 10C shows a graph of refractive index and optical absorption coefficient for the ZrO₂ film of FIG. 10B after performing annealing at 300 degrees C.

FIG. 11A shows a graph of refractive index and optical absorption coefficient for an example uncured ZrₓTi_{y}Oₙ film deposited using an acid-stabilized liquid phase precursor solution.

FIG. 11B shows a graph of refractive index and optical absorption coefficient for the ZrₓTi_{y}Oₙ film of FIG. 11A after performing UV light curing.

FIG. 11C shows a graph of refractive index and optical absorption coefficient for the ZrₓTi_{y}Oₙ film of FIG. 11B after performing annealing at 300 degrees C.

FIG. 12A shows a graph of refractive index and optical absorption coefficient for an example uncured CeₓTi_{y}Oₙ film deposited using an acid-stabilized liquid phase precursor solution.

FIG. 12B shows a graph of refractive index and optical absorption coefficient for the CeₓTi_{y}Oₙ film of FIG. 12A after performing UV light curing.

FIG. 12C shows a graph of refractive index and optical absorption coefficient for the CeₓTi_{y}Oₙ film of FIG. 12B after performing annealing at 300 degrees C.

FIG. 13A shows a graph of refractive index and optical absorption coefficient for an example uncured LaₓTi_{y}Oₙ film deposited using an acid-stabilized liquid phase precursor solution.

FIG. 13B shows a graph of refractive index and optical absorption coefficient for the LaₓTi_{y}Oₙ film of FIG. 13A after performing UV light curing.

FIG. 13C shows a graph of refractive index and optical absorption coefficient for the LaₓTi_{y}Oₙ film of FIG. 13B after performing annealing at 300 degrees C.

FIG. 14A shows a graph of refractive index and optical absorption coefficient for an example uncured LiₓLa_{y}Ti_{z}Oₙ film deposited using an acid-stabilized liquid phase precursor solution.

FIG. 14B shows a graph of refractive index and optical absorption coefficient for the LiₓLa_{y}Ti_{z}Oₙ film of FIG. 14A after performing UV light curing.

FIG. 14C shows a graph of refractive index and optical absorption coefficient for the LiₓLa_{y}Ti_{z}Oₙ film of FIG. 14B after performing annealing at 300 degrees C.

FIG. 15A shows a graph of refractive index and optical absorption coefficient for an example uncured LiₓBi_{y}Ti_{z}Oₙ film deposited using an acid-stabilized liquid phase precursor solution.

FIG. 15B shows a graph of refractive index and optical absorption coefficient for the LiₓBi_{y}Ti_{z}Oₙ film of FIG. 15A after performing UV light curing.

FIG. 15C shows a graph of refractive index and optical absorption coefficient for the LiₓBi_{y}Ti_{z}Oₙ film of FIG. 15B after performing annealing at 400 degrees C.

FIG. 16A shows a graph of refractive index and optical absorption coefficient for an example uncured Nb_{w}LaₓLi_{y}Ti_{z}Oₙ film deposited using an acid-stabilized liquid phase precursor solution.

FIG. 16B shows a graph of refractive index and optical absorption coefficient for the Nb_{w}LaₓLi_{y}Ti_{z}Oₙ film of FIG. 16A after performing UV light curing.

FIG. 16C shows a graph of refractive index and optical absorption coefficient for the Nb_{w}LaₓLi_{y}Ti_{z}Oₙ film of FIG. 16B after performing annealing at 300 degrees C.

FIG. 17A shows a graph of refractive index and optical absorption coefficient for an example uncured AlᵥNb_{w}LaₓLi_{y}Ti_{z}Oₙ film deposited using an acid-stabilized liquid phase precursor solution.

FIG. 17B shows a graph of refractive index and optical absorption coefficient for the AlᵥNb_{w}LaₓLi_{y}Ti_{z}Oₙ film of FIG. 17A after performing UV light curing.

FIG. 17C shows a graph of refractive index and optical absorption coefficient for the AlᵥNb_{w}LaₓLi_{y}Ti_{z}Oₙ film of FIG. 17B after performing annealing at 300 degrees C.

FIG. 18A shows a graph of refractive index and optical absorption coefficient for an example uncured HfO₂ film deposited using an acid-stabilized liquid phase precursor solution.

FIG. 18B shows a graph of refractive index and optical absorption coefficient for the HfO₂ film of FIG. 18A after performing UV light curing.

FIG. 18C shows a graph of refractive index and optical absorption coefficient for the HfO₂ film of FIG. 18B after performing annealing at 300 degrees C.

FIG. 19A shows a graph of refractive index and optical absorption coefficient for an example uncured LiₓTi_{y}Oₙ film deposited using an acid-stabilized liquid phase precursor solution.

FIG. 19B shows a graph of refractive index and optical absorption coefficient for the LiₓTi_{y}Oₙ film of FIG. 19A after performing UV light curing.

FIG. 19C shows a graph of refractive index and optical absorption coefficient for the LiₓTi_{y}Oₙ film of FIG. 19B after performing annealing at 300 degrees C.

FIG. 20A shows a graph of refractive index and optical absorption coefficient for an example uncured SrₓTi_{y}Oₙ film deposited using an acid-stabilized liquid phase precursor solution.

FIG. 20B shows a graph of refractive index and optical absorption coefficient for the SrₓTi_{y}Oₙ film of FIG. 20A after performing UV light curing.

FIG. 20C shows a graph of refractive index and optical absorption coefficient for the SrₓTi_{y}Oₙ film of FIG. 20B after performing annealing at 300 degrees C.

FIG. 21A shows a graph of refractive index and optical absorption coefficient for an example uncured YₓTi_{y}Oₙ film deposited using an acid-stabilized liquid phase precursor solution.

FIG. 21B shows a graph of refractive index and optical absorption coefficient for the YₓTi_{y}Oₙ film of FIG. 21A after performing UV light curing.

FIG. 21C shows a graph of refractive index and optical absorption coefficient for the YₓTi_{y}Oₙ film of FIG. 21B after performing annealing at 300 degrees C.

FIG. 22A shows a graph of refractive index and optical absorption coefficient for an example uncured NbₓTi_{y}Oₙ film deposited using an acid-stabilized liquid phase precursor solution.

FIG. 22B shows a graph of refractive index and optical absorption coefficient for the NbₓTi_{y}Oₙ film of FIG. 22A after performing UV light curing.

FIG. 22C shows a graph of refractive index and optical absorption coefficient for the NbₓTi_{y}Oₙ film of FIG. 22B after performing annealing at 300 degrees C.

FIG. 23A shows a graph of refractive index and optical absorption coefficient for an example uncured SnₓTi_{y}Oₙ film deposited using an acid-stabilized liquid phase precursor solution.

FIG. 23B shows a graph of refractive index and optical absorption coefficient for the SnₓTi_{y}Oₙ film of FIG. 23A after performing UV light curing.

FIG. 23C shows a graph of refractive index and optical absorption coefficient for the SnₓTi_{y}Oₙ film of FIG. 23B after performing annealing at 300 degrees C.

FIG. 24A shows a graph of refractive index and optical absorption coefficient for an example uncured BiₓTi_{y}Oₙ film deposited using an acid-stabilized liquid phase precursor solution.

FIG. 24B shows a graph of refractive index and optical absorption coefficient for the BiₓTi_{y}Oₙ film of FIG. 24A after performing UV light curing.

FIG. 24C shows a graph of refractive index and optical absorption coefficient for the BiₓTi_{y}Oₙ film of FIG. 24B after performing annealing at 300 degrees C.

FIG. 25A shows a graph of refractive index and optical absorption coefficient for an example uncured Al₂O₃ film deposited using an acid-stabilized liquid phase precursor solution.

FIG. 25B shows a graph of refractive index and optical absorption coefficient for the Al₂O₃ film of FIG. 25A after performing UV light curing.

FIG. 25C shows a graph of refractive index and optical absorption coefficient for the Al₂O₃ film of FIG. 25B after performing annealing at 300 degrees C.

FIG. 26A shows a graph of refractive index and optical absorption coefficient for an example uncured LiₓAl_{y}Oₙ film deposited using an acid-stabilized liquid phase precursor solution.

FIG. 26B shows a graph of refractive index and optical absorption coefficient for the LiₓAl_{y}Oₙ film of FIG. 26A after performing UV light curing.

FIG. 26C shows a graph of refractive index and optical absorption coefficient for the LiₓAl_{y}Oₙ film of FIG. 26B after performing annealing at 300 degrees C.

FIG. 27A shows a graph of refractive index and optical absorption coefficient for an example uncured SrₓAl_{y}Oₙ film deposited using an acid-stabilized liquid phase precursor solution.

FIG. 27B shows a graph of refractive index and optical absorption coefficient for the SrₓAl_{y}Oₙ film of FIG. 27A after performing UV light curing.

FIG. 27C shows a graph of refractive index and optical absorption coefficient for the SrₓAl_{y}Oₙ film of FIG. 27B after performing annealing at 300 degrees C.

FIG. 28A shows a graph of refractive index and optical absorption coefficient for an example uncured YₓAl_{y}Oₙ film deposited using an acid-stabilized liquid phase precursor solution.

FIG. 28B shows a graph of refractive index and optical absorption coefficient for the YₓAl_{y}Oₙ film of FIG. 28A after performing UV light curing.

FIG. 28C shows a graph of refractive index and optical absorption coefficient for the YₓAl_{y}Oₙ film of FIG. 28B after performing annealing at 300 degrees C.

FIG. 29A shows a graph of refractive index and optical absorption coefficient for an example uncured NbₓAl_{y}Oₙ film deposited using an acid-stabilized liquid phase precursor solution.

FIG. 29B shows a graph of refractive index and optical absorption coefficient for the NbₓAl_{y}Oₙ film of FIG. 29A after performing UV light curing.

FIG. 29C shows a graph of refractive index and optical absorption coefficient for the NbₓAl_{y}Oₙ film of FIG. 29B after performing annealing at 300 degrees C.

FIG. 30A shows a graph of refractive index and optical absorption coefficient for an example uncured SnₓAl_{y}Oₙ film deposited using an acid-stabilized liquid phase precursor solution.

FIG. 30B shows a graph of refractive index and optical absorption coefficient for the SnₓAl_{y}Oₙ film of FIG. 30A after performing UV light curing.

FIG. 30C shows a graph of refractive index and optical absorption coefficient for the SnₓAl_{y}Oₙ film of FIG. 30B after performing annealing at 300 degrees C.

FIG. 31A shows a graph of refractive index and optical absorption coefficient for an example uncured BiₓAl_{y}Oₙ film deposited using an acid-stabilized liquid phase precursor solution.

FIG. 31B shows a graph of refractive index and optical absorption coefficient for the BiₓAl_{y}Oₙ film of FIG. 31A after performing UV light curing.

FIG. 31C shows a graph of refractive index and optical absorption coefficient for the BiₓAl_{y}Oₙ film of FIG. 31B after performing annealing at 300 degrees C.

FIG. 32A shows a graph of refractive index and optical absorption coefficient for an example uncured LaₓAl_{y}Oₙ film deposited using an acid-stabilized liquid phase precursor solution.

FIG. 32B shows a graph of refractive index and optical absorption coefficient for the LaₓAl_{y}Oₙ film of FIG. 32A after performing UV light curing.

FIG. 32C shows a graph of refractive index and optical absorption coefficient for the LaₓAl_{y}Oₙ film of FIG. 32B after performing annealing at 300 degrees C.

FIGS. 33 and 34 show images of example patterns formed in an optical waveguide fabricated from TiO₂ according to the methods described in the present disclosure.

### DETAILED DESCRIPTION

Examples are disclosed that relate to the formation of metal oxide films via a liquid-phase deposition using an acid-stabilized precursor solution. As described in more detail below, the example precursor solutions can omit organic species such as alkoxo ligands, and thereby can be deposited, dried, and cured at lower temperatures than precursor solutions comprising organic species. Further, the addition of acids to the precursor solutions can form stable precursor solutions with relatively long shelf lives, based upon times for observed precipitate formation. A variety of precursor solutions can be formed and used in liquid-phase deposition of metal oxide films as disclosed. In some examples, an aqueous acid-stabilized precursor solution according to the present disclosures can comprises one or more group 4 or 13 ions and one or more other ions from group 1 and/or group 2 and/or group 3, and/or group 4, and/or group 5, and/or group 13 and/or group 14 and/or group 15 and/or F-block ions, referring to groups in the periodic table of the elements. Some illustrative examples include TiO₂, AlₓTi_{y}Oₙ, NbₓTi_{y}Oₙ, TiO₂/TiO₂ nanoparticle composites, other metal oxide/metal oxide nanoparticle composites, ZrO₂, ZrₓTi_{y}Oₙ, CeₓTi_{y}Oₙ, LaₓTi_{y}Oₙ, LiₓLa_{y}Ti_{z}O_{nz}, LiₓBi_{y}Ti_{z}Oₙ, Nb_{w}LaₓLi_{y}Ti_{z}Oₙ, and AlᵥNb_{w}LaₓLi_{y}Ti_{z}Oₙ. Metal oxide films prepared as disclosed can be used for a potentially wide variety of applications. Examples include optical films, energy storage, semiconductor devices, Photonic Integrated Circuits (PICs), and biomedical devices. As a more specific example, TiO₂ and mixed metal oxide/TiO₂ acid-stabilized precursor solutions according to the disclosed examples can be used to deposit titanium oxide films with high-thermal stability (>800° C.), high-optical transparency (>90% @ 550 nm), and tunable refractive indices (1.7<n<2.5). Compositions and post-deposition processing can be controlled to modulate refractive index and optical transparency.

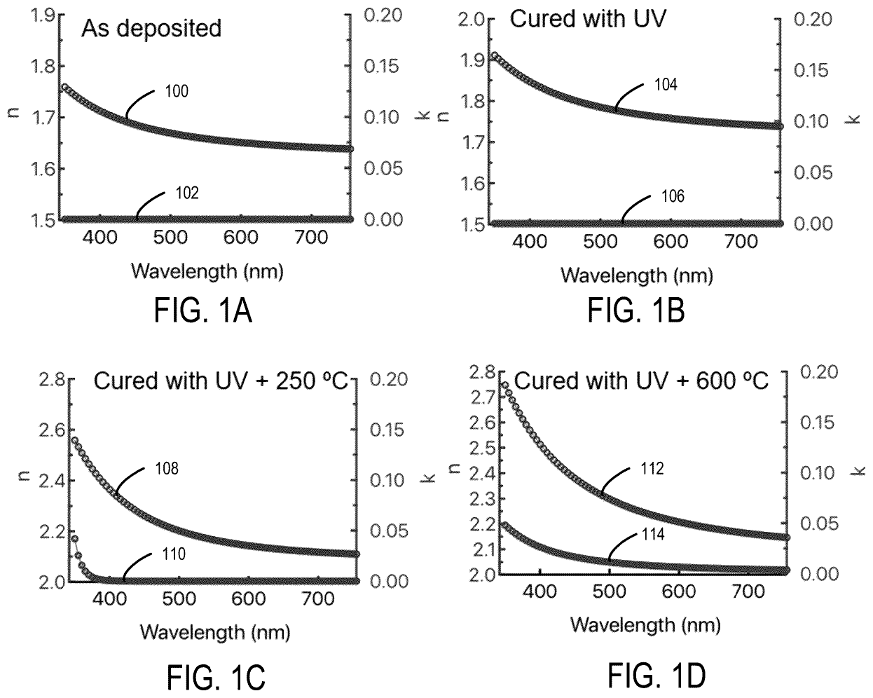

The disclosed example precursor solutions may be deposited on substates by any suitable method. Examples include spin coating, dip coating, doctor blading, Spray coating, electrodeposition, and printing methods (e.g. jet printing, screen printing, etc.). The disclosed example precursor solutions can be formed from various different metal-containing compounds. For example, a precursor solution for forming a TiO₂ film can be formed from titanium-containing species such as TiO₂, TiCl₃·xHCl (x=0-200), and/or TiCl₄(1). A precursor solution according to the present disclosure can be aqueous, and/or can include another suitable solvent. A precursor according to the present disclosure also includes a photolyzable and/or pyrolyzable ligand. The term “photolyzable and/or pyrolyzable ligands” represents ligands that that decompose or otherwise leave a film formed by the precursor solution when exposed to light (e.g. UV light) and/or sufficient heat. Photolyzable and/or pyrolyzable ligands can include oxygen-containing ligands. In FIG. 1, hydrogen peroxide is shown as an example UV sensitive ligand. In other examples, other suitable UV-curable ligands may be used. Examples include other peroxides (e.g. lithium peroxide, sodium peroxide, etc.), formic acid or other carboxylic acids, and nitrate ions. Further, in some examples, an organic peroxide or acid may be used as a photolyzable and/or pyrolyzable ligand. However, organic peroxides may require the use of additional safety measures due to the potential low stability and combustibility of organic peroxides. Formic acid and hydrogen peroxide offer the additional advantage that no carbon from organic species needs to be removed by a relatively high-temperature post-deposition heating step, as the carbon in formic acid converts to CO₂ gas upon curing of the deposited film. As illustrative examples, a titanium-containing precursor solution can include, as examples, TiX₃ (x=Cl⁻, Br⁻, I⁻, NO₃⁻, OOCH⁻, etc.)+H₂O₂, TiX₄ (x=Cl⁻, Br⁻, I⁻, NO₃, OOCH⁻, etc.)+H₂O₂, or TiOSO₄+H₂O₂ as metal source/ligand combinations. Other example metal-containing compounds for precursor solutions are described below.

As mentioned above, the precursor solutions according to the present disclosure are acid stabilized. Acid stabilization may increase a shelf life of a precursor solution from minutes to months, and even to indefinite periods (e.g. years), in some examples. For example, with regard to titanium-containing precursor solutions, the following was observed with regard to acid stabilization v. no acid stabilization.

A first titanium dioxide film precursor solution was prepared by mixing freshly precipitated TiO₂ and H₂O₂ in water. The dissolved species may potentially have taken the form of Ti(OH)₄+H₂O₂(aq). The reaction between the titanium dioxide and hydrogen peroxide ligand was extremely exothermic. The resulting solution was stable for less than 5 minutes, based on precipitation formation. It further was found that stability depends on concentration, with higher titanium concentrations being less stable.

A second titanium dioxide film precursor solution was prepared by mixing an aqueous solution of TiCl₃ and HCl with H₂O₂. The HCl-stabilized solutions were stable for more than 10 months when kept at 10 degrees Celsius. No precipitation was observed. However, the color of the solution changed from red to colorless after 10 months. The red solution can be regenerated by mixing additional H₂O₂ into the precursor solution.

A third titanium dioxide film precursor solution was prepared by mixing TiCl₄(1) with aqueous H₂O₂. TiCl₄ forms HCl when mixed with water, thereby forming an acid-stabilized solution. This solution was also found to be stable for more than 30 days, based upon precipitate formation.

A fourth titanium dioxide precursor solution was prepared by mixing an aqueous solution of TiCl₃·xHCl with aqueous sulfuric acid (H₂SO₄) and aqueous hydrogen peroxide. The resulting precursor solution was stable indefinitely, based upon precipitate formation. Titanium oxysulfate (TiOSO₄) can be substituted for sulfuric acid in some examples.

In the first example above, the first precursor solution did not include an acid species. Adding the peroxide to the TiO₂*xH₂O precipitate in solution lead to a vigorous exothermic reaction. Further, the resulting solution forms a precipitate within minutes, and thus has low shelf-stability. In contrast, in the second, third and fourth examples above, acid species were included in the precursor solutions, along with a titanium species and hydrogen peroxide. These solutions had a longer observed stability, with the HCl-stabilized solutions being stable for more than 30 days, and the solution comprising HCl and H₂SO₄ being stable indefinitely.

FIGS. 1A-1D show experimental data illustrating refractive indices and optical absorption coefficients as a function of temperature for example TiO₂ films. The films were deposited by spin coating 4 mL of a precursor solution comprising TiCl₃·3HCl (aq) (30%) mixed with 1.5 mL of H₂O₂ (aq) (30%). Spin coating was performed at 3000 RPM for 30 s. After spin coating, the samples were UV cured by exposing to UV light in a Novascan UV/O3 tool (available from Novascan Technologies of Boone, IA) for 5 minutes. After UV curing, some samples were thermally cured by annealing for 10 minutes at a selected temperature in a muffle furnace.

FIG. 1A shows refractive index 100 and optical absorption coefficient 102 data for the as-deposited, uncured films. Referring next to FIG. 1B, UV curing increases the refractive index 104 compared to an uncured film. The optical absorption coefficient 106 remains low for the entire visible spectrum. Further, referring to FIGS. 1C-1D, annealing after curing further increases the refractive index, shown at 108 in FIG. 1C and 112 in FIG. 1D. The film cured at 600 degrees Celsius had a higher optical absorption coefficient 114 in the blue range of the visible spectrum compared to the optical absorption coefficient 110 of the film cured at 250 degree Celsius. Thus, an annealing temperature can be used to tailor the optical properties of a film.

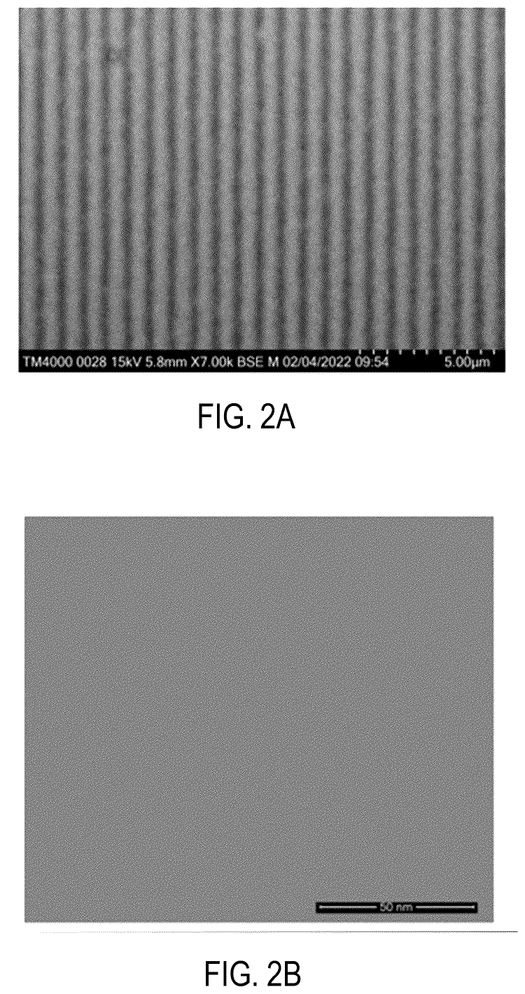

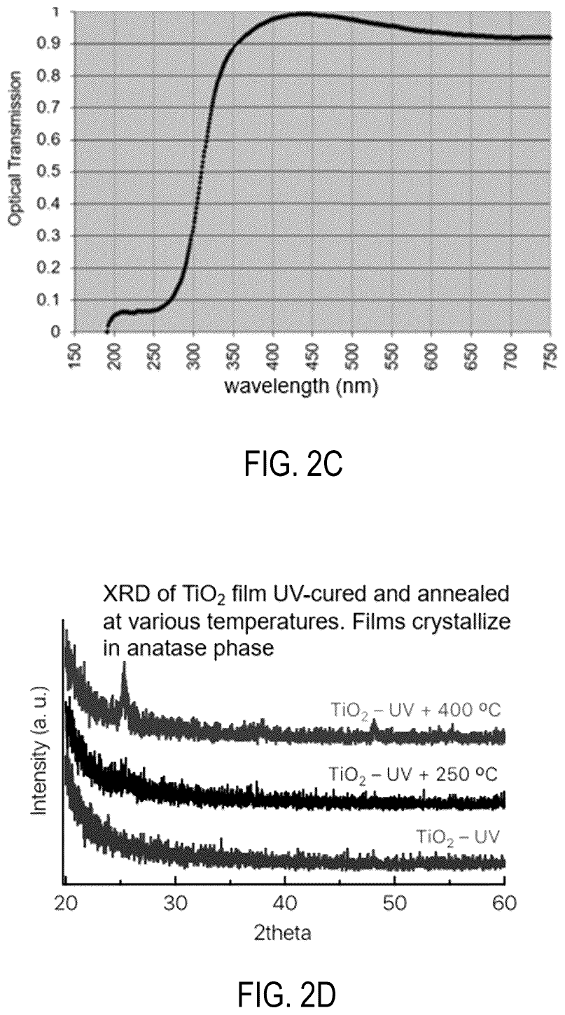

FIGS. 2A-2D shows other experimental data from films prepared using the example precursor solution of FIG. 2. First, FIG. 2A shows an SEM image of an example TiO₂ film imprinted using a transparent shim (e.g. polydimethylsiloxane (PDMS), quartz, glass etc.), after UV cure and annealing at 250° C. The TiO₂ films were prepared as described above for FIGS. 1A-1D, in that the films were spin coated, UV cured, and then annealed at various temperatures. FIG. 2A illustrates that a pattern can be printed into the film and fixed by curing/annealing with suitable levels of line edge roughness. The film of FIG. 2A was annealed at 250 degrees Celsius. FIG. 2B shows an SEM image of a blanket TiO₂ film, and illustrates that the disclosed example precursor solutions can form smooth films after spin-coating, curing, and annealing. Referring next to FIG. 2C, optical transmission data for a blanket TiO₂ film cured at 250 degrees Celsius shows that the blanket film is highly transmissive throughout the visible range (e.g. above 0.9 for wavelengths>350 nm). Referring next to FIG. 2D, XRD data show that the UV-cured but unannealed film is primarily amorphous. The XRD data further shows that some anatase phase appears after annealing at 250 degrees Celsius for 10 minutes, and that the anatase phase is more prominent after annealing at 400 degrees Celsius.

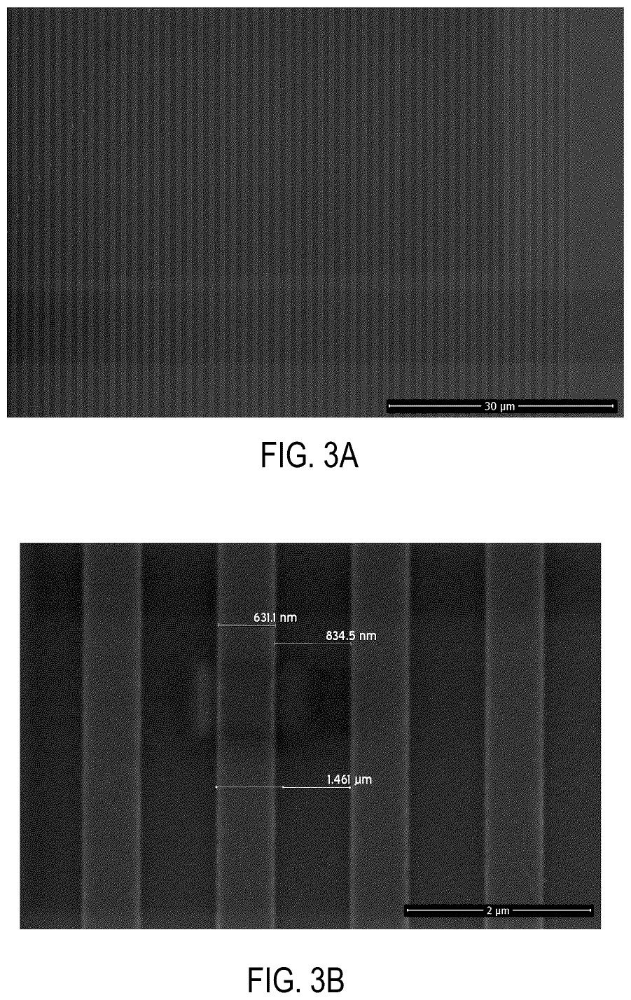

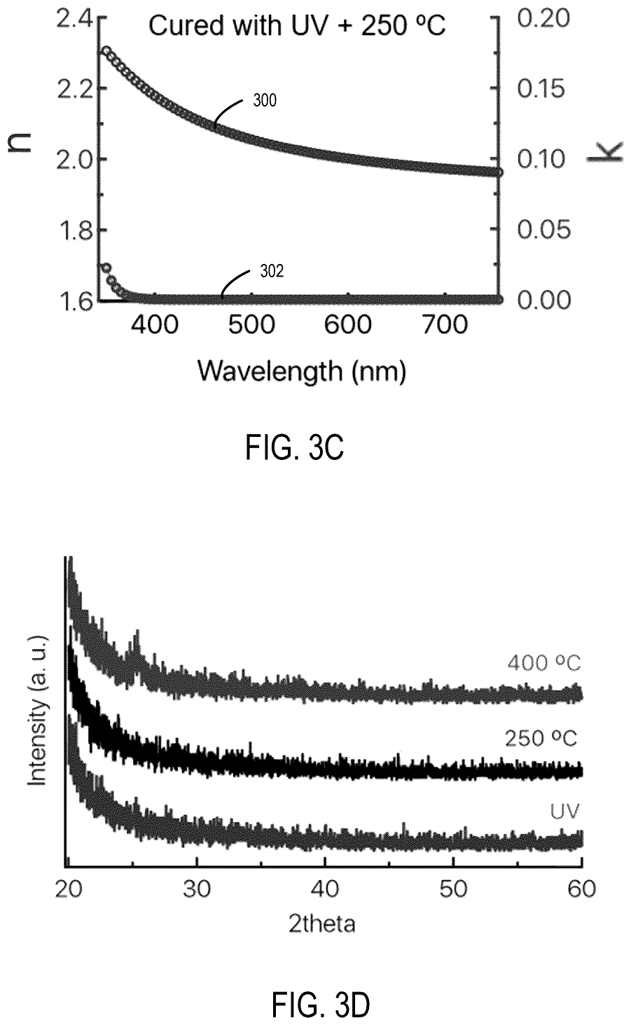

FIGS. 3A-3D show experimental data from an aluminum-titanium oxide film deposited using a precursor solution according to the present disclosure. The TiO₂-Al₂O₃ films were deposited by spin coating 4 mL of a precursor solution comprising TiCl₃·3HCl (aq) (30%) mixed with 1.5 mL of H₂O₂ (aq) (30%) and 2 mL 0.07M Al₁₃(OH)₂₄(H₂O)₂₄(NO₃)₁₅(aq). Spin coating was performed at 3000 RPM for 30 s. After spin coating, the samples were UV cured by exposing to UV light in a Novascan UV/O3 tool for 5 minutes. After UV curing, some samples were thermally cured by annealing for 10 minutes at a selected temperature in a muffle furnace. As illustrated by the SEM images of FIGS. 3A-3B, a pattern can be imprinted into an example Ti/Al oxide film formed from the disclosed example precursor solution. Further, referring next to FIG. 3C, a refractive index of the Ti/Al oxide film 300 at an arbitrary wavelength (e.g. 500) is different than the refractive index of the TiO₂ film of FIG. 2 that was annealed similarly. This shows that the refractive index of an optical film can be modulated by varying metal ions used in combination with titanium. Optical absorption coefficient data is shown at 302 in FIG. 3C. Also, referring to FIG. 3D, x-ray diffraction data shows that the material remains substantially amorphous after UV curing, and also after thermal annealing at 250 degrees Celsius. The material also remains substantially amorphous after annealing at 400 degrees Celsius, except for a broad anatase peak (101 Miller indices) appearing at about 25 degrees 2theta.

Any suitable other metal(s) may be used than Ti may be used in an acid stabilized precursor solution according to the present disclosure. Examples include other transition metals than titanium that may be dissolved into a precursor solution comprising a UV-curable ligand (e.g. a peroxide or formic acid) and a stabilizing acid (e.g. HCl, HNO₃, and/or H₂SO₄), such as Al, Ga, Bi, Sc, Cu, Al, Sc, V, Cr, Mn, Fe, Co, Ni, Zn, Y, Zr, Nb, Mo, In, Sn, Sb, Hf, Ta, W, Ir, Pt, La, Ce, Pr, Nd, Pm, Sm, Eu, Gd, Tb, Dy, Ho, Er, Tm, Yb, Lu, and combinations of two or more thereof.

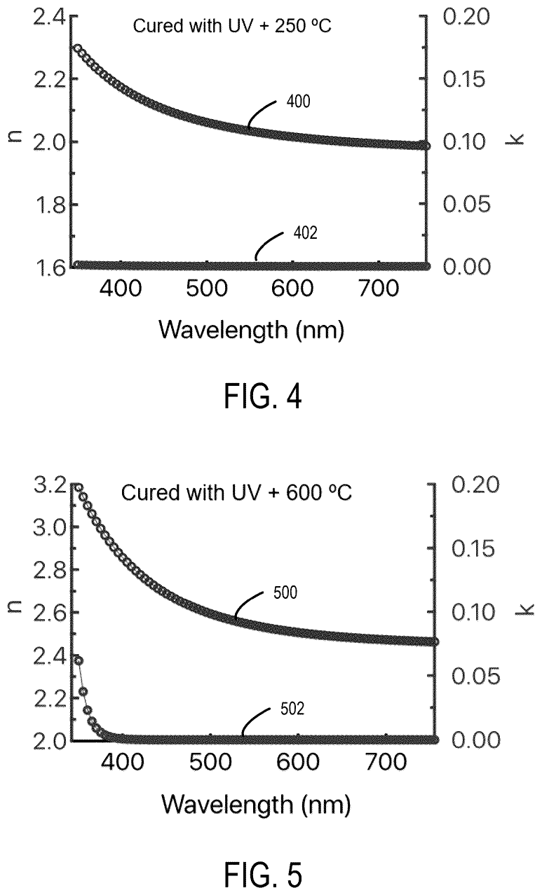

FIG. 4 shows refractive index 400 and optical absorbance coefficient 402 data for a mixed Nb/Ti oxide film. Again, the refractive index at an arbitrary wavelength (e.g. 500 nm) is different than for the Ti/Al oxide film or the TiO₂ film, indicating that refractive index and/or dispersion can be modulated by composition. The mixed Nb/Ti oxide film of FIG. 4 was produced by spin coating a substrate with a precursor solution prepared from 4 mL of TiCl₃·3HCl (aq) (30%)+1.5 mL H₂O₂ (aq) (30%)+0.5 g NbCl₅ (s). The precursor solution was spun coat at 3000 RPM for 30 s. UV-cured samples were cured using a Novascan UV/O3 tool for 5 min. Thermally cured films were annealed for 10 min at 250 degrees Celsius in a muffle furnace. As such, a refractive index of a Ti-containing oxide film according to the present disclosure may be tuned by varying the identities and/or concentrations of metal species mixed with the titanium. While the examples in FIGS. 3A-3D and 4 each show a single other metal species mixed with titanium in a titanium-containing oxide film, in other examples two or more other metal species may be mixed with titanium in a titanium-containing oxide film. Further examples are described in more detail below.

As the disclosed example films are deposited as a liquid phase and undergo UV curing and/or annealing, some shrinkage in film thickness may occur as crosslinking between ligand-bound Ti atoms occurs during curing, and as water is driven from the film. Thus, in some examples, to help reduce shrinking, a precursor may be used that includes a population of nanoparticles. The nanoparticles have a higher density than the ligand-bound metal ions. Thus, incorporating the nanoparticles into a precursor may help reduce film shrinkage during curing and annealing. FIG. 5 shows refractive index 500 and absorption coefficient 502 data for a TiO₂ film comprising TiO₂ nanoparticles that were formed in situ in a precursor solution. The precursor solution was formed by mixing 4 mL TiCl₃·3HCl (aq) (30%), 1.5 mL H₂O₂ (aq) (30%), and 1 mL Ti(OC₃H₇)₄ (96%) (1). Samples were prepared by spin coating the solution on substrates at 3000 RPM for 30 s. UV-cured samples were cured using a Novascan UV/O3 tool for 5 min. Thermally cured films were annealed for 10 min at 600 degrees Celsius in a muffle furnace after UV curing. The resulting films had an increased index of refraction and decreased observed film shrinkage compared to a TiO₂ film prepared from a precursor solution without TiO₂ nanoparticles. While the annealing temperature for the film in this example was 600 degrees Celsius, a nanoparticle-containing film formed by depositing a nanoparticle-containing precursor solution as disclosed may be annealed at lower or higher temperatures in other examples. Example annealing temperatures for all examples in this disclosure include, but are not limited to, annealing temperatures within a range of 60-650 degrees C.

In the example of FIG. 5, an isopropoxide ligand is used to form the nanoparticles in situ. In other examples, any other suitable ligand may be used. As different ligands may lead to the growth of nanoparticles of different sizes and shapes, a desired nanoparticle size may be a factor in ligand selection. Further, while the in situ nanoparticles of FIG. 5 comprise TiO₂ nanoparticles, in other examples, in situ-formed nanoparticles may comprise a different metal species, or two or more metal species. Further, in some examples, nanoparticles formed ex situ (e.g. outside of the precursor solution) may be added to a precursor solution. Additionally, in some examples a second metal species may be added to a precursor solution after forming nanoparticles of a first metal species. For example, a Nb species, Al species, or another metal may be added after forming TiO₂ nanoparticles. Likewise, a Ti species may be added after forming nanoparticles of another metal oxide (e.g. ZrO₂, SnO₂, Nb₂O₅, Al₂O₃).

While the examples disclosed herein utilize a UV curing process, in other examples any other suitable curing process may be used. Examples include thermal curing, laser curing, and particle beam (e.g. electron beam) curing.

Depending upon film composition and processing conditions, films according to the present disclosure may have different degrees of crystallinity. For example, a metal oxide film annealed at a relatively higher temperature may have a greater degree of crystallinity than a similar film annealed at a lower temperature. Further, where a film comprises titanium plus an additional metal species, if the oxide of the additional metal species crystallizes in a different structure than TiO₂ (e.g. does not crystallize in a rutile, anatase, or brookite), the presence of the different metal species may help to reduce a level of crystallinity of the film compared to a TiO₂ film cured and annealed under similar conditions.

Metal oxide films formed from acid-stabilized precursors solutions as disclosed herein may be used in any suitable device. As one example, a metal oxide film as disclosed herein may be used as a light extraction layer or encapsulation layer in an organic light-emitting diode (OLED) display panel. The disclosed metal oxide films also may be used as other waveguides, as optical claddings, and in optical components such as dichroic beam splitters, light diffuser, anti-reflective layers, cold mirrors, and hot mirrors. Further, acid-stabilized precursors solutions as disclosed herein also can be used to form solid electrolyte films for solid state batteries.

Deposition of a metal oxide film according to the present disclosure can be performed more quickly and cheaply than an atomic layer deposition (ALD) process for forming metal oxide films of a same or similar chemical composition. Additionally, the disclosed metal oxide films can have a lower density than a same or similar metal oxide film deposited by ALD, and thus can be etched at a higher rate than metal oxide films formed by ALD. The faster deposition and etch rates can produce an overall increase in throughput in the manufacture of optical waveguides compared to ALD-based manufacturing processes. Further, in some embodiments, the refractive index of a metal oxide film according to the present disclosure can be tuned by temperature selection during curing and/or annealing steps.

The disclosed films also can enable the etching of more complex structures, such as slanted gratings. For example, ALD-deposited TiO₂ can etch slowly. This causes the TiO₂ to have a relatively low etch selectivity with regard to photoresist. Etching slanted gratings with a low selectivity resist can cause shadowing effects. As a result, etching ALD-deposited TiO₂ may require the use of a hard mask. This can increase manufacturing cost and complexity. In contrast, the liquid-phase TiO₂ films as disclosed can have higher etch selectivity due to the lower density of the films prior to annealing. This may enable the etching of complex structures without having to use hard masks for the etching process.

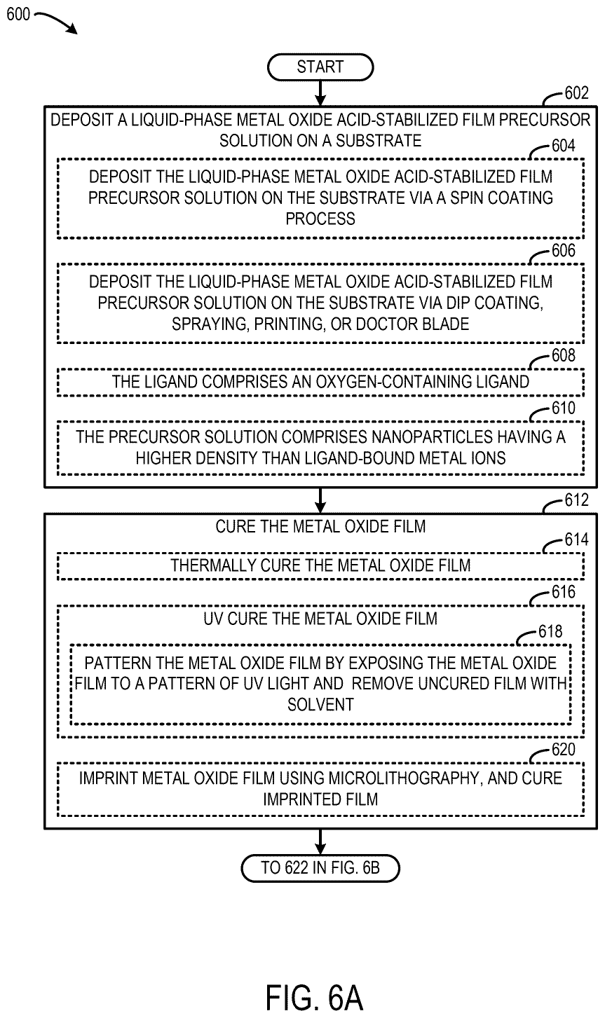

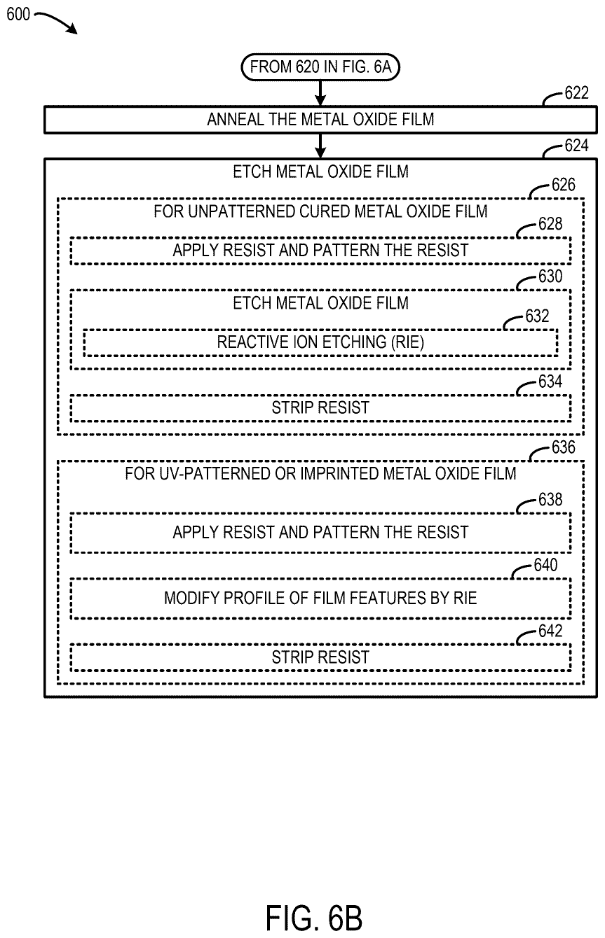

FIGS. 6A-6B show an example method 600 of fabricating an optical waveguide high-index metal oxide films deposited using acid-stabilized liquid phase precursor solutions. Similar methods can be used to deposit metal oxide films for other applications, such as for use as solid electrolytes. In FIG. 6A, at 602, the method 600 includes depositing a liquid-phase metal oxide acid-stabilized metal film precursor solution on a substrate. As mentioned above, the acid-stabilized precursor solution comprises a solvent, a metal ion species, a Photolyzable/Pyrolyzable ligand, and an acid, such as hydrochloric acid, nitric acid, and/or sulfuric acid. In some examples, the precursor solution is aqueous, and includes a titanium species, such as TiO₂, TiCl₃*xHCl (x=0-200), and/or TiCl₄(1). In other examples, the precursor solution may include other types of metals. Examples include other transition metals than titanium that may be dissolved into an acid-stabilized precursor solution comprising an photolyzable/pyrolyzable ligand, such as Al, Ga, Bi, Sc, Cu, Al, Sc, V, Cr, Mn, Fe, Co, Ni, Zn, Y, Zr, Nb, Mo, In, Sn, Sb, Hf, Ta, W, Ir, Pt, La, Ce, Pr, Nd, Pm, Sm, Eu, Gd, Tb, Dy, Ho, Er, Tm, Yb, and Lu. Further, in some examples, two or more metal ions may be dissolved in the precursor solution.

The metal oxide film may be deposited on the substrate using any suitable solution deposition process. For example, at 604, the metal oxide film can be coated onto the substrate via a spin coating process. In other examples, at 606, the metal oxide film can be coated onto the substrate via dip coating, spraying, printing, or doctor blade. Suitable substrates include hydrophilic materials, as well as materials that can be make hydrophilic by a treatment such as plasma exposure and/or exposure to an adhesion promoter (e.g. SurPass 3000, available from DisChem, Inc. of Ridgway, PA. Example substrate materials include glass (SiO₂), doped silicon oxide, titanium oxide, and silicon nitride.

As mentioned above, the acid-stabilized precursor solution comprises a photolyzable and/or pyrolyzable ligand. The photolyzable and/or pyrolyzable ligand helps to solubilize the metal ion species in solution. Any suitable ligand that decomposes by exposure to ultraviolet light or otherwise leaves the film at low temperature can be used. The ligand and acid act to stabilize the precursor solutions by preventing metal ions from bonding together and forming an oxide phase. When deposited as a film and exposed to UV light or sufficient heat, the ligand decomposes or leaves the film, allowing metal ions to form M-O-M linkages. This allows the metal oxide phase to form. Some example UV photosensitive ligands include hydrogen peroxide, other peroxides (e.g. lithium peroxide, sodium peroxide, etc.), nitrate ions, and formic acid. In some examples, an organic peroxide or acid may be used as a UV-curable ligand. However, organic peroxides may require the use of additional safety measures due to the potential low stability and combustibility of organic peroxides. Further, as mentioned above, a relatively high-temperature post-deposition heating step may be required to remove carbon from the organic peroxide or acid. Formic acid and hydrogen peroxide offer the additional advantage that no carbon from organic species needs to be removed by such a post-deposition heating step (e.g. carbon in the formic acid evolves as CO₂ upon film formation/curing).

As the disclosed example films are deposited as a liquid phase and undergo curing, some shrinkage in film thickness may occur as crosslinking between ligand-bound Ti atoms occurs during curing, and as water or other solvent (polyethylene glycol methyl ethyl acetate (PGMEA), as another illustrative example) is driven from the film. As such, in some implementations, at 610, the precursor solution may comprise nanoparticles having a higher density than ligand-bound metal ions. The inclusion of such nanoparticles in the precursor solution can help reduce film shrinkage during curing and annealing due to the higher density of the nanoparticles. The nanoparticles can comprise any suitable material for desired optical properties. In some examples, TiO₂ nanoparticles can be used. In other examples, the nanoparticles may comprise a different metal oxide, or two or more different metal oxides. In various examples, the nanoparticles can be formed in-situ (in the precursor solution) or ex situ (e.g. outside of the precursor solution).

At 612, the method 600 includes curing the metal oxide film. The curing process forms bonds between ligand-bound metal ions, and drives volatile species including solvent from the film, thereby increasing a density of the metal oxide film. Any suitable curing process can be used. For example, at 614, the metal oxide film may be thermally cured. The metal oxide film may be thermally cured at any suitable temperature. In examples where the precursor solution includes organic species such as alkoxo ligands, the metal oxide film may be cured at a higher temperature to volatilize carbon species in the film. In some examples, the curing temperature may affect optical characteristics of the metal oxide film/optical waveguide. For example, a titanium oxide film cured at 600 degrees Celsius was found to have a higher refractive index and a higher optical absorption coefficient in the blue range of the visible spectrum compared to a titanium oxide film cured at 250 degrees Celsius. Thus, in some examples, a curing process may be selected to achieve desired optical properties. In some examples, suitable curing temperatures can include temperatures as low as 60 degrees Celsius and as high as 800 degrees Celsius.

In some implementations, at 616, alternatively or additionally the metal oxide film may be cured by exposing the metal oxide film to UV light. UV curing can chemically activate UV-photosensitive ligands, such as peroxides and nitrate, allowing the UV-photosensitive ligands to react and form chemical bonds. This can form a robust and interconnected metal oxide film.

UV curing also can be used to pattern the metal oxide film, as indicated at 618. For example, a shadow mask can be applied over the film, or the metal oxide film can be exposed to a focused and suitably high contrast UV image. Exposed portions of the metal oxide film will cure, while other portions will remain uncured. Uncured portions then can be removed by solvent, leaving behind the cured portions of the metal film.

In some implementations where a patterned resist is applied to the metal oxide film, at 620, the method 600 may include curing a portion of the metal oxide film that has the patterned resist on the substrate. In this case, a portion of the metal oxide film that does not have the patterned resist remains uncured, such that it can be removed during a development process.

Turning to FIG. 6B, at 622, in some examples, method 600 includes annealing the metal oxide film after curing the metal oxide film. The annealing process can modify a surface morphology and/or bulk morphology of the metal oxide. Further, annealing also can modify a refractive index of the cured metal oxide film. The metal oxide film may be annealed at any suitable temperature. Example annealing temperatures include temperatures within a range of 60-650 degrees C. In some examples, the annealing temperature can be selected to produce a desired refractive index and absorption coefficient for the metal oxide film. In some examples, the metal oxide film may undergo two or more annealing cycles. In other examples, annealing may be performed at a temperature outside of this range or may be omitted.

Continuing, at 624, the method 600 etching the metal oxide film. Etching may be used on an unpatterned metal oxide film to form desired waveguide structures. Examples include pillars, channels, gratings, lenses, and nanostructures such as metasurface features. In examples in which a solid state electrolyte is being formed, rather than a waveguide, etching can be used to form the solid state electrolyte into a desired pattern for a battery system as well as increasing the surface area.

In some implementations, at 626, a metal oxide film may not have been patterned during curing. In such implementations, the method 600 comprises, at 628, applying a resist to the metal oxide film and patterning the resist (e.g., by UV light by exposure and solvent development or nanoimprint lithography (NIL)). Next, at 630, the metal oxide film is etched using a suitable etching process. Areas covered by resist are not etched, while areas that are exposed due to resist development are etched. Any suitable etching process can be used. Examples include dry etching processes such as reactive ion etching (RIE), as indicated at 632. RIE has the advantage of being directional, allowing deeper features to be formed with less horizontal etching that undercuts the substrate areas protected by the resist. Another example of a suitable etching processes includes sputter etching (e.g. ion beam milling). In some examples, etching may be performed on-axis (i.e. normal to a metal oxide film surface) to produce vertical structures. In other examples, etching may be performed off-axis to produce slanted/diagonal structures. Other example etching processes include atomic layer etching and wet etching processes. After etching, method 600 comprises stripping the resist at 634.

At 636, where the metal oxide film was patterned during the curing process, such as by imprinting or curing using a pattern of UV light, an etching process can be used to sharpen features on the patterned film, such as edges and corners. Thus, method 600 can comprise, at 638, applying a resist to the metal oxide film and patterning the resist, and at 640, modifying a profile of features of the metal oxide film using reactive ion etching or other suitable etching method. As the prior patterning can potentially form loosely defined features (e.g., dull edges), the RIE can help to sharpen such features to produce a more accurate pattern. After etching, the resist is stripped at 642.

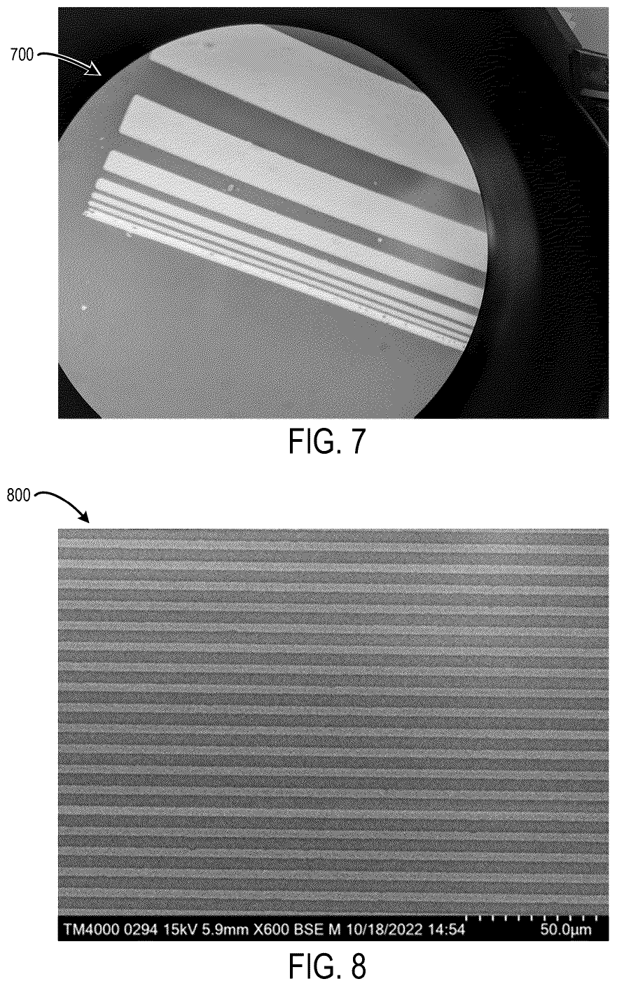

FIG. 7 shows an optical image 700 of an example pattern etched in an optical waveguide fabricated according to the method disclosed herein. This example shows that features of different aspect ratios can be formed in a metal oxide layer of an optical waveguide using the method disclosed herein. Such an ability to produce a wide variety of features provides the flexibility to fabricate many different types of optical waveguides having different optical features and patterns.

The UV-curable precursor solutions of the present disclosure further can be used as photoresists. Various oxide films formed using precursor solutions of the present disclosure may have a slower etch rate than currently used photoresists, yet can be deposited and patterned more efficiently than a hardmask. As such, oxide films formed using precursor solutions of the present disclose also may be used as higher selectivity resists in etching processes such as reactive ion etching (RIE) compared to current photoresists.

FIG. 8 shows an example scanning electron microscope (SEM) image 800 of an example pattern etched in an optical waveguide fabricated according to the method disclosed herein. To obtain the example pattern, a titanium oxide layer was spin coated onto a substrate, then baked at 250C. Then, photoresist (here, Microposit Photoresist-S1813, available from Shipley Company of Marlborough, MA) was spin coated on top of the metal oxide layer and patterned by lithography. Then, the pattern was developed by washing un-exposed photoresist with a suitable solvent. Then, the pattern was etched by RIE. The SEM image 300 has a zoom level of 50 microns. It can be seen at this zoom level that the features (e.g., pillars and channels) are repeated in the pattern with high accuracy and consistency. In other words, the fabrication method disclosed herein is able to produce an optical waveguide having highly accurate and consistent optical features.

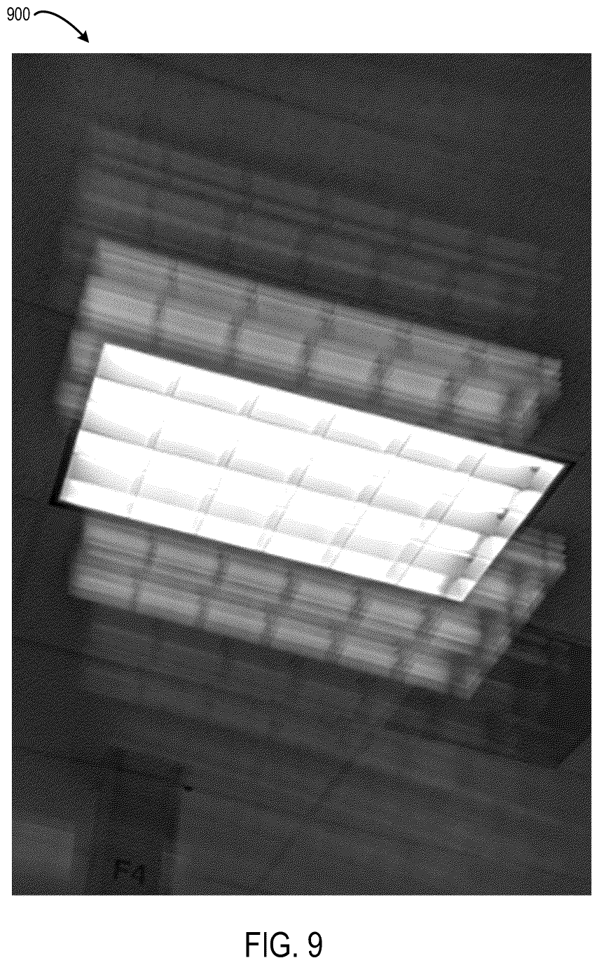

FIG. 9 shows an example optical image 900 of a scene (a ceiling light fixture) as viewed through a patterned optical waveguide formed by reactive ion etching of a metal oxide film deposited using an acid-stabilized liquid phase precursor solution. The optical image 900 is looking through a patterned waveguide. The optical image 900 shows multiple a zero-order image of the light fixture, plus multiple higher orders on each side of the zero order.

Depending upon film composition and processing conditions, films according to the present disclosure may have different degrees of crystallinity. For example, a TiO₂ film annealed at a relatively higher temperature may have a greater degree of crystallinity than a similar film annealed at a lower temperature. Further, where a film comprises titanium plus an additional metal species, if the oxide of the additional metal species crystallizes in a different structure than TiO₂ (e.g. does not crystallize in a rutile, anatase, or brookite), the presence of the different metal species may help to reduce a level of crystallinity of the film compared to a TiO₂ film cured and annealed under similar conditions. Examples of other metal oxide films, with and without titanium, are described below.

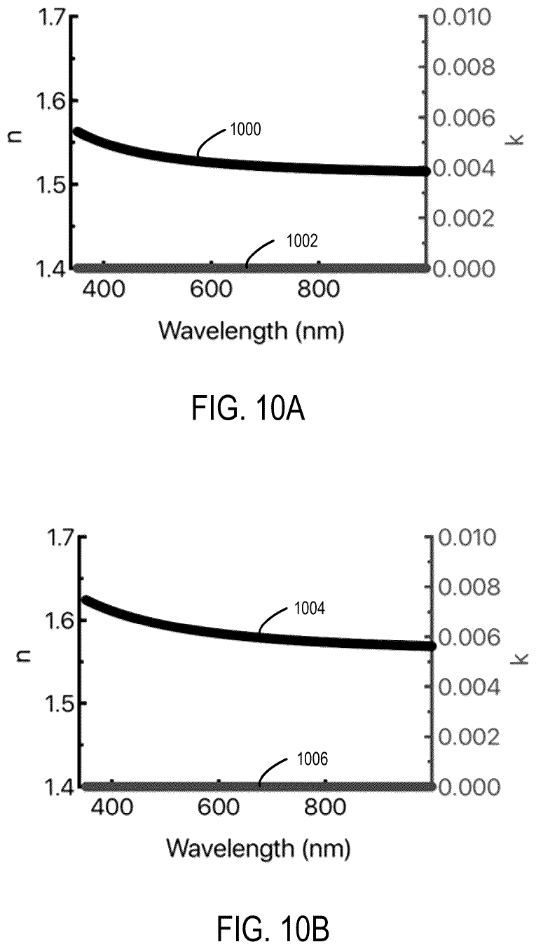

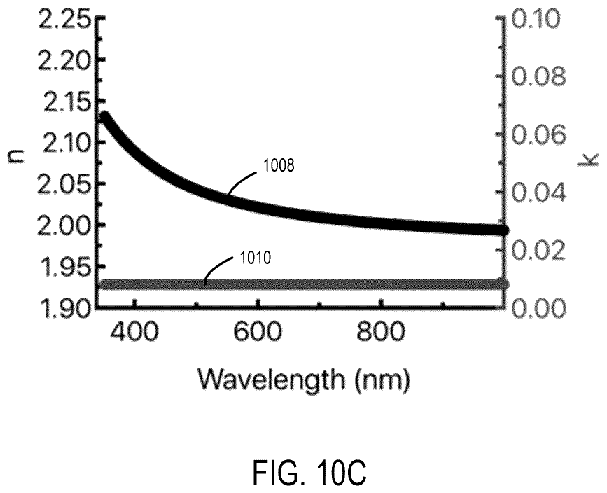

FIG. 10A shows a graph of refractive index 1000 and optical absorption coefficient 1002 for another group 4 metal oxide—an example uncured ZrO₂ film deposited using an acid-stabilized liquid phase precursor solution. The precursor solution was prepared by mixing 10 g ZrO(NO₃)₂·xH₂O(s), 10 mL HNO₃ (aq), 3 mL H₂O₂ (aq) (30%)+1 mL formic acid (aq). Solutions were spin coated at 3000 RPM for 30 s. FIG. 10B shows a graph of refractive index 1004 and optical absorption coefficient 1006 for a ZrO₂ film after performing UV light curing using a Novascan UV/O3 tool for 5 min. As can be seen, the refractive index rose upon UV curing. Further, both films are optically transparent across the visible wavelength range. FIG. 10C shows a graph of refractive index 1008 and optical absorption coefficient 1010 for a ZrO₂ film after annealing at 300 degrees Celsius for 10 minutes. As can be seen, the refractive index is higher than for the uncured and the UV cured films. Thus, ZrO₂ film properties for a ZrO₂ film deposited using an acid-stabilized precursor solution according to the present disclosure can be modulated by UV curing and/or thermal annealing.

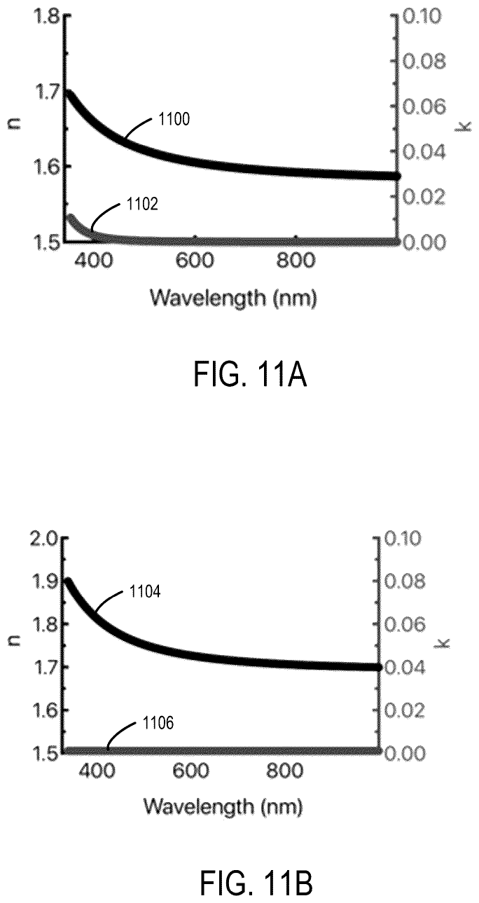

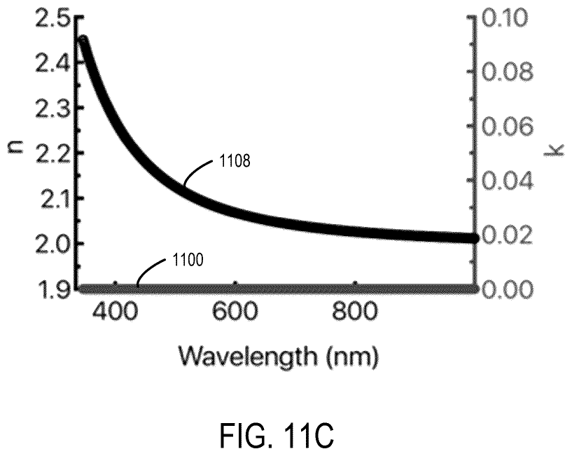

FIG. 11A shows a graph of refractive index 1100 and optical absorption coefficient 1102 for an example uncured ZrₓTi_{y}Oₙ film deposited using an acid-stabilized liquid phase precursor solution. An acid-stabilized Zr precursor solution was prepared first by mixing 1 g ZrOCl(s), 1 mL HCl (aq), 1 mL H₂O₂ (aq) (30%), and 1 mL formic acid (aq). Next, 4.5 mL of Ti precursor solution was added. The Ti precusor solution was prepared by mixing 4 mL TiCl₃·3HCl (30%) (aq) and 0.5 mL H₂O₂ (aq) (30%). FIG. 11B shows a graph of refractive index 1104 and optical absorption coefficient 1106 for a ZrₓTi_{y}Oₙ film after performing UV light curing using a Novascan UV/O3 tool for 5 min. As can be seen, the refractive index rose upon UV curing across the visible spectrum compared to the uncured film of FIG. 11A. Further, both films are optically transparent across the visible spectrum. FIG. 11C shows a graph of refractive index 1108 and optical absorption coefficient 1110 for a ZrₓTi_{y}Oₙ film after annealing at 300 degrees Celsius for 10 minutes. As can be seen, the refractive index is higher than those of the uncured and the UV cured films. Thus, film properties for a ZrₓTi_{y}Oₙ film deposited using an acid-stabilized precursor solution according to the present disclosure can be modulated by UV curing and/or thermal annealing.

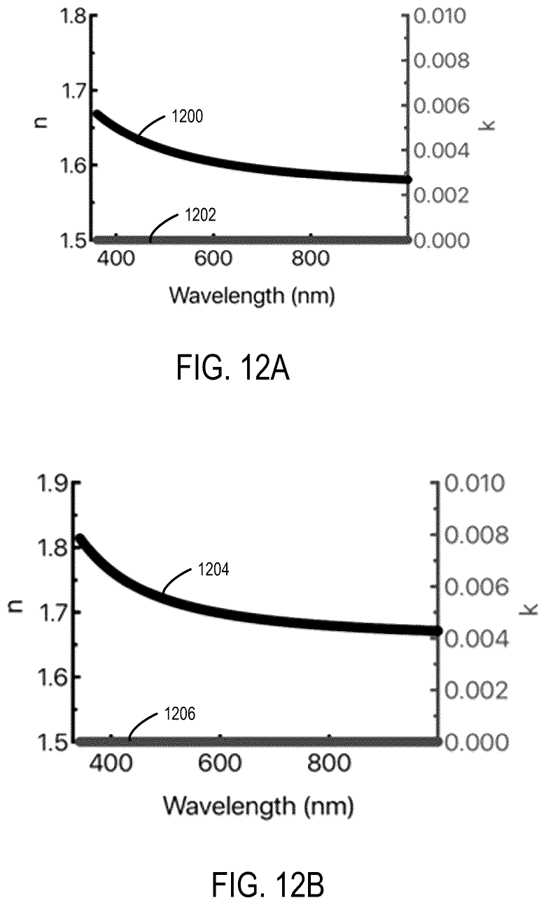

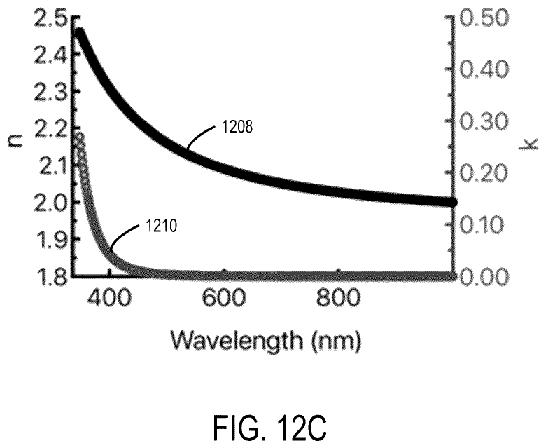

FIG. 12A shows a graph of refractive index 1200 and optical absorption coefficient 1202 for an example uncured CeₓTi_{y}Oₙ film deposited using an acid-stabilized liquid phase precursor solution. CeO₂ was added to keep the resulting film amorphous after curing and annealing. An acid-stabilized Ce precursor solution was prepared by mixing 1 g Ce(OH)₄(s), 2 mL HCl (aq), and 1 mL H₂O₂ (aq) (30%). Next, 4.5 mL of Ti precursor solution was added. The Ti precusor solution was prepared by mixing 4 mL TiCl₃·3HCl (30%) (aq) and 0.5 mL H₂O₂ (aq) (30%). Solutions were spin coated at 3000 RPM for 30 s. FIG. 12B shows a graph of refractive index 1204 and optical absorption coefficient 1206 for a CeₓTi_{y}Oₙ film after performing UV light curing using a Novascan UV/O3 tool for 5 min. As can be seen, the refractive index rose upon UV curing across the visible spectrum compared to the uncured film of FIG. 12A. Further, both films are optically transparent across the visible spectrum.

FIG. 12C shows a graph of refractive index 1208 and optical absorption coefficient 1210 for a CeₓTi_{y}Oₙ film after annealing at 300 degrees Celsius for 10 minutes. As can be seen, the refractive index is higher than for the uncured and the UV cured films. Further, the annealed film of FIG. 12C has some optical absorbance in the lower wavelengths of the visible spectrum. Thus, film properties for a CeₓTi_{y}Oₙ film deposited using an acid-stabilized precursor solution according to the present disclosure can be modulated by UV curing and/or thermal annealing.

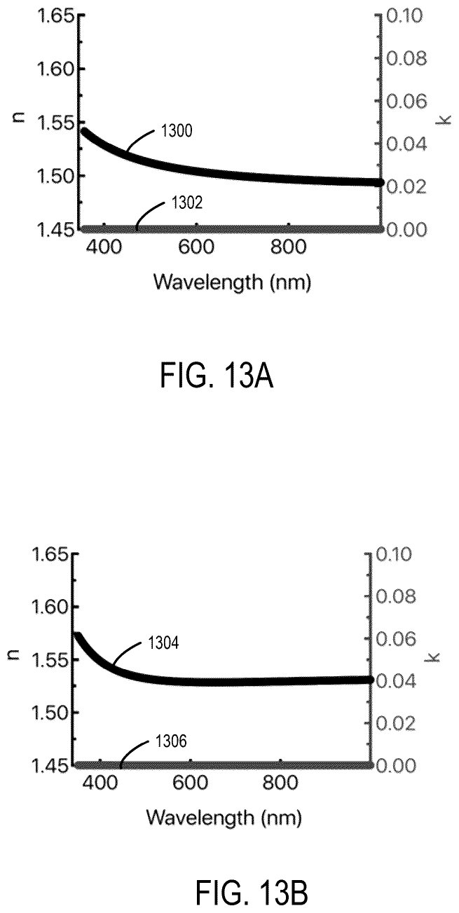

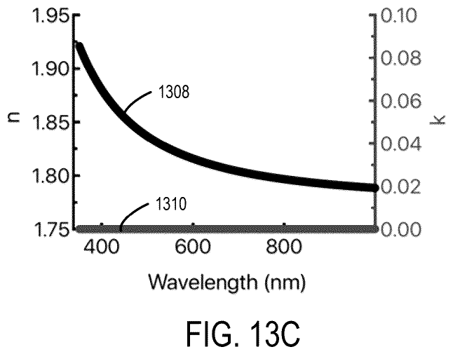

FIG. 13A shows a graph of refractive index 1300 and optical absorption coefficient 1302 for an example uncured LaₓTi_{y}Oₙ film. An acid-stabilized La precursor solution was prepared by mixing 1 g LaCl₃(s), 2 mL HCl (aq), and 3 mL H₂O₂ (aq) (10%). Next, 4.5 mL of Ti precursor solution was added. The Ti precusor solution was prepared by mixing 4 mL TiCl₃·3HCl (30%) (aq) and 0.5 mL H₂O₂ (aq) (30%). Solutions were spin coated at 3000 RPM for 30 s. FIG. 13B shows a graph of refractive index 1304 and optical absorption coefficient 1306 for a LaₓTi_{y}Oₙ film after performing UV light curing using a Novascan UV/O3 tool for 5 min. As can be seen, the refractive index rose upon UV curing across the visible spectrum compared to the uncured film of FIG. 13A. Further, both films are optically transparent across the visible spectrum. FIG. 13C shows a graph of refractive index 1308 and optical absorption coefficient 1310 for a LaₓTi_{y}Oₙ film after annealing at 300 degrees Celsius for 10 minutes. As can be seen, the refractive index is higher than for the uncured and the UV cured films. Thus, film properties for a LaₓTi_{y}Oₙ film deposited using an acid-stabilized precursor solution according to the present disclosure can be modulated by UV curing and/or thermal annealing.

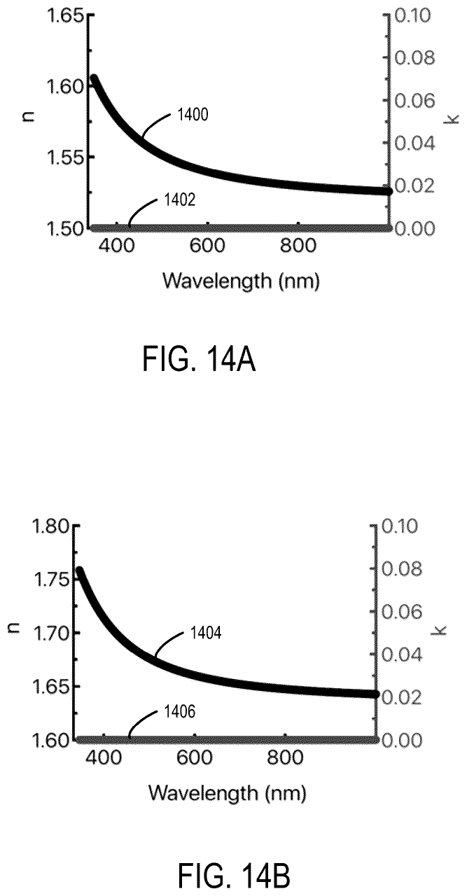

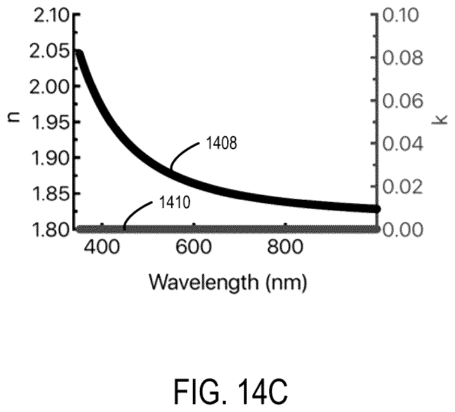

The oxide films of FIGS. 10A-13C above each contain one or two metal species. In some examples, an oxide film comprising three or more metal oxide species can be formed. FIG. 14A shows a graph of refractive index 1400 and optical absorption coefficient 1402 for an example uncured LiₓLa_{y}Ti_{z}Oₙ film deposited using an acid-stabilized liquid phase precursor solution. Lithium lanthanum titanium oxide can be used as solid electrolytes for solid state batteries. As such, the disclosed depositions of acid-stabilized liquid phase precursors for oxide film deposition may conveniently be used to form solid electrolyte films for solid state batteries.

An acid-stabilized La precursor solution was prepared by mixing 1.85 g LaCl₃.7H₂O (s), 3 mL HCl (aq) and 5 mL H₂O₂ (aq) (10%). Next, 4.5 mL of Ti precursor solution was added. The Ti precursor solution was prepared by mixing 4 mL TiCl₃·3HCl (30%) (aq) and 0.5 mL H₂O₂ (aq) (30%). Lastly, 0.211 g LiCl (s) was added. Samples were deposited by spin coating at 3000 RPM for 30 s. FIG. 13B shows a graph of refractive index 1404 and optical absorption coefficient 1406 for a LiₓLa_{y}Ti_{z}Oₙ film after performing UV light curing using a Novascan UV/O3 tool for 5 min. As can be seen, the refractive index rose upon UV curing across the visible spectrum compared to the uncured film of FIG. 14A. Further, both films are optically transparent across the visible spectrum. FIG. 14C shows a graph of refractive index 1408 and optical absorption coefficient 1410 for a LiₓLa_{y}Ti_{z}Oₙ film after annealing at 300 degrees Celsius for 10 minutes. As can be seen, the refractive index is than for the uncured and the UV cured films. Thus, a LiₓLa_{y}Ti_{z}Oₙ film deposited using an acid-stabilized precursor solution according to the present disclosure can be modulated by UV curing and/or thermal annealing.

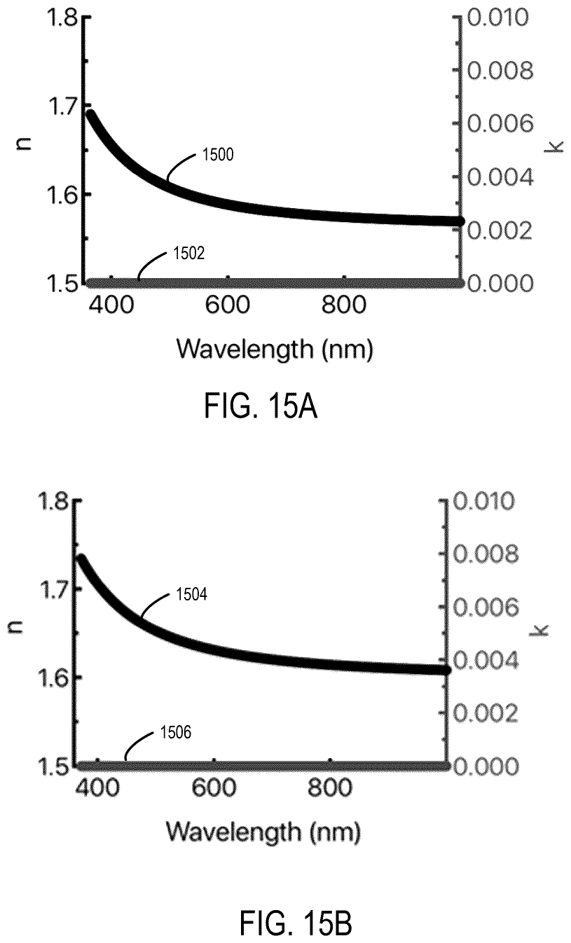

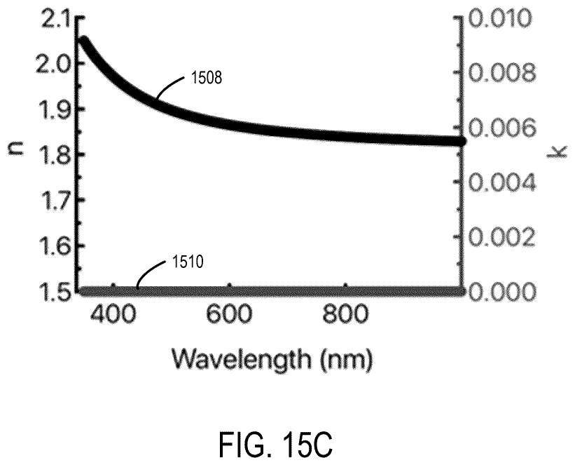

Lithium bismuth titanium oxide is another material that can be used as a solid electrolyte in a solid state battery. FIG. 15A shows a graph of refractive index 1500 and optical absorption coefficient 1502 for an example uncured LiₓBi_{y}Ti_{z}Oₙ film deposited using an acid-stabilized liquid phase precursor solution. An acid-stabilized Bi precursor solution was prepared by mixing 2.43 g Bi(NO₃)₃.5H₂O (s), 1 mL HCl (aq), and 1 mL H₂O₂ (aq) (30%). Next, 4.5 mL of Ti precursor solution was added. The Ti precursor solution was prepared by mixing 4 mL TiCl₃·3HCl (30%) (aq) and 0.5 mL H₂O₂ (aq) (30%). Then, 0.211 g LiCl (s) was added. Samples were deposited by spin coating at 3000 RPM for 30 s. FIG. 15B shows a graph of refractive index 1504 and optical absorption coefficient 1506 for a LiₓBi_{y}Ti_{z}Oₙ film after performing UV light curing using a Novascan UV/O3 tool for 5 min. As can be seen, the refractive index rose upon UV curing across the visible spectrum compared to the uncured film of FIG. 15A. Further, both films are optically transparent across the visible spectrum.

FIG. 15C shows a graph of refractive index 1508 and optical absorption coefficient 1510 for a LiₓBi_{y}Ti_{z}Oₙ film after annealing at 300 degrees Celsius for 10 minutes. As can be seen, the refractive index is than for the uncured and the UV cured films. Thus, a LiₓBi_{y}Ti_{z}Oₙ film deposited using an acid-stabilized precursor solution according to the present disclosure can be modulated by UV curing and/or thermal annealing. Further, the use of an acid-stabilized precursor solution as disclosed may provide for a convenient method for forming solid electrolyte materials for solid state batteries.

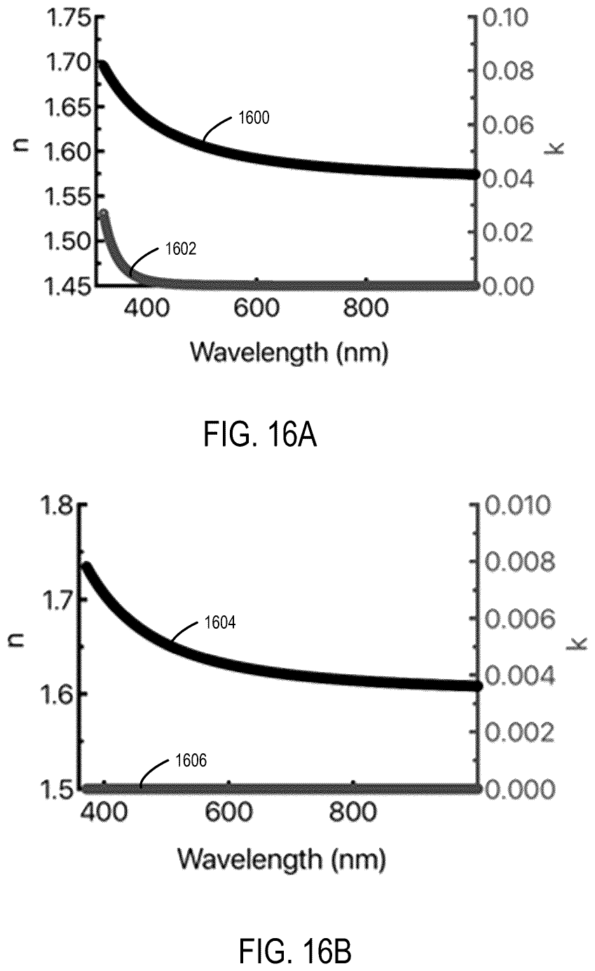

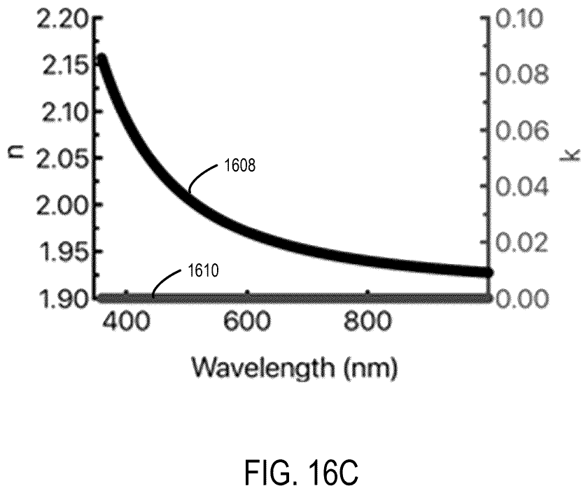

The oxide films of FIGS. 14A-15C each contain three species. In some examples, an oxide film comprising four or more metal oxide species can be formed. FIG. 16A shows a graph of refractive index 1600 and optical absorption coefficient 1602 for an example uncured Nb_{w}LaₓLi_{y}Ti_{z}Oₙ film deposited using an acid-stabilized liquid phase precursor solution. An acid-stabilized Nb precursor solution was prepared by mixing 1.26 g NbCl₅(s), 3 mL HCl (aq), and 1 mL H₂O₂ (aq) (30%). This was then added to 3 mL of the solution used to spin coat the samples of FIG. 14A-14C. Then, 1 mL H₂O₂ (aq) (30%) was added to avoid precipitate formation. FIG. 16B shows a graph of refractive index 1604 and optical absorption coefficient 1606 for a Nb_{w}LaₓLi_{y}Ti_{z}Oₙ film after performing UV light curing using a Novascan UV/O3 tool for 5 min. As can be seen, the refractive index rose upon UV curing across the visible spectrum compared to the uncured film of FIG. 16A. Further, both films are optically transparent across the visible spectrum. FIG. 16C shows a graph of refractive index 1608 and optical absorption coefficient 1610 for a Nb_{w}LaₓLi_{y}Ti_{z}Oₙ film after annealing at 300 degrees Celsius for 10 minutes. As can be seen, the refractive index is than for the uncured and the UV cured films. Thus, an acid-stabilized precursor solution according to the present disclosure can be used to deposit metal oxide films comprising four or more metals. This can help to achieve potentially wide range of film properties and also encourage formation of amorphous films.

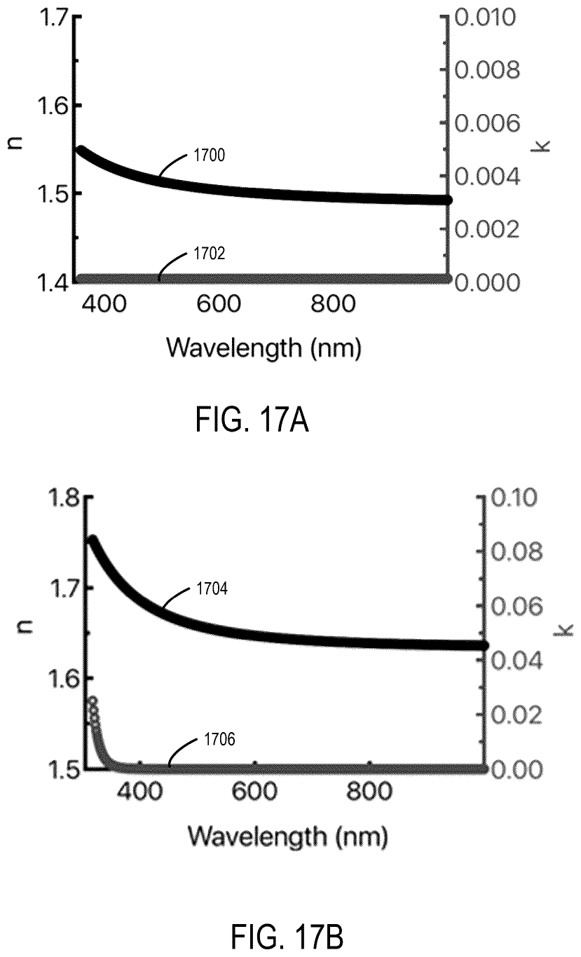

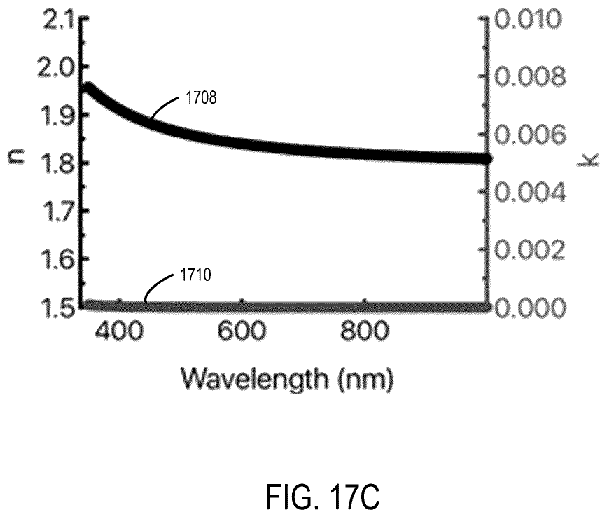

FIG. 17A shows a graph of refractive index 1700 and optical absorption coefficient 1702 for an example uncured AlᵥNb_{w}LaₓLi_{y}Ti_{z}Oₙ film deposited using an acid-stabilized liquid phase precursor solution. The film of FIG. 17A was deposited using a precursor formed by mixing 2 mL of the precursor solution used to deposit the films of FIGS. 16A-16C with 1 mL of 1 mL of 0.1M Al₁₃(OH)₂₄(H₂O)₂₄(NO₃)₁₅(aq). The solution was spin coated at 3000 RPM for 30 s. FIG. 17B shows a graph of refractive index 1704 and optical absorption coefficient 1706 for a AlᵥNb_{w}LaₓLi_{y}Ti_{z}Oₙ film after performing UV light curing using a Novascan UV/O3 tool for 5 min. As can be seen, the refractive index rose upon UV curing across the visible spectrum compared to the uncured film of FIG. 17A. The UV-cured film of FIG. 17B has some optical absorbance in the lower wavelength range of the visible spectrum.

FIG. 17C shows a graph of refractive index 1608 and optical absorption coefficient 1710 for a AlᵥNb_{w}LaₓLi_{y}Ti_{z}Oₙ film after annealing at 300 degrees Celsius for 10 minutes. As can be seen, the refractive index is than for the uncured and the UV cured films. Thus, an acid-stabilized precursor solution according to the present disclosure can be used to deposit metal oxide films comprising five or more metals. Again, this can help to achieve potentially wide range of film properties and also encourage formation of amorphous films.

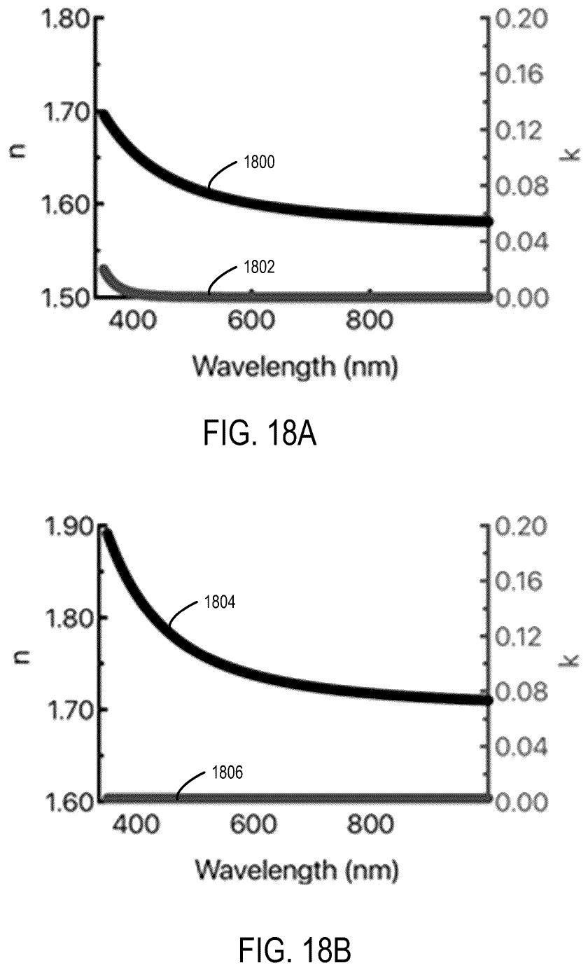

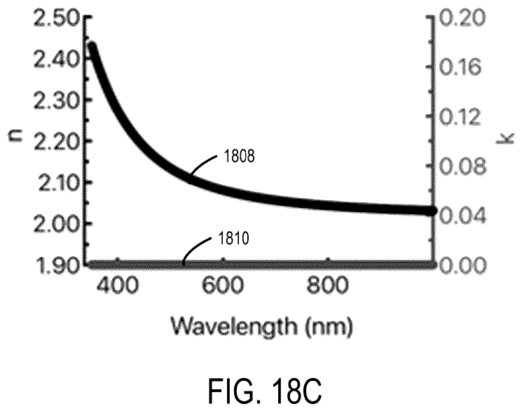

FIG. 18A shows a graph of refractive index 1800 and optical absorption coefficient 1802 for an example uncured HfO₂ film deposited using an acid-stabilized liquid phase precursor solution. The film of FIG. 18A was deposited using a precursor formed by mixing 2 g HfOCl₂(s), 5 mL HCl (aq), 3 mL H₂O₂ (aq) (30%), and 1 mL formic acid (aq). The solution was spin coated at 3000 RPM for 30 s. FIG. 18B shows a graph of refractive index 1804 and optical absorption coefficient 1806 for a HfO₂ film after performing UV light curing using a Novascan UV/O3 tool for 5 min. As can be seen, the refractive index rose upon UV curing across the visible spectrum compared to the uncured film of FIG. 18A. The UV-cured film of FIG. 18B has less optical absorbance in the lower wavelength range of the visible spectrum than the uncured film of FIG. 18A. FIG. 18C shows a graph of refractive index 1808 and optical absorption coefficient 1810 for a HfO₂ film after annealing at 300 degrees Celsius for 10 minutes. As can be seen, the refractive index is higher than for the uncured and the UV cured films.

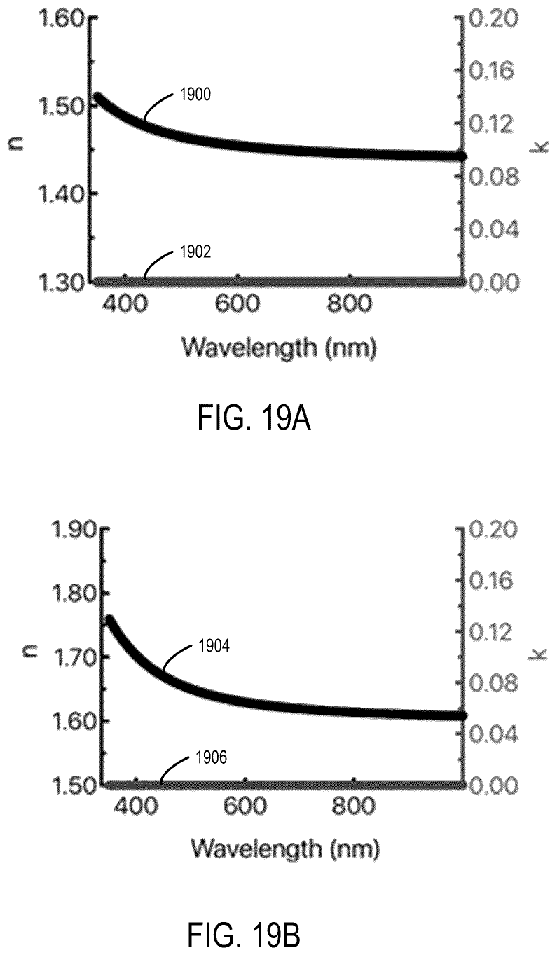

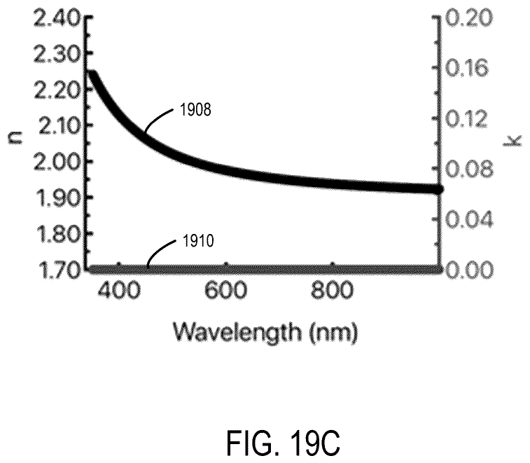

FIG. 19A shows a graph of refractive index 1900 and optical absorption coefficient 1902 for an example uncured LiₓTi_{y}Oₙ film deposited using an acid-stabilized liquid phase precursor solution. The film of FIG. 19A was deposited using a precursor formed by mixing 4 mL TiCl₃·3HCI (30%) (aq), 0.5 mL H₂O₂ (aq) (30%), and 0.25 g LiCl(s), and sonicating for five minutes. The solution was spin coated at 3000 RPM for 30 s. FIG. 19B shows a graph of refractive index 1904 and optical absorption coefficient 1906 for a Li₂O+TiO₂ film after performing UV light curing using a Novascan UV/O3 tool for 5 min. As can be seen, the refractive index rose upon UV curing across the visible spectrum compared to the uncured film of FIG. 19A. FIG. 19C shows a graph of refractive index 1908 and optical absorption coefficient 1910 for a LiₓTi_{y}Oₙ film after annealing at 300 degrees Celsius for 10 minutes. As can be seen, the refractive index is higher than for the uncured and the UV cured films.

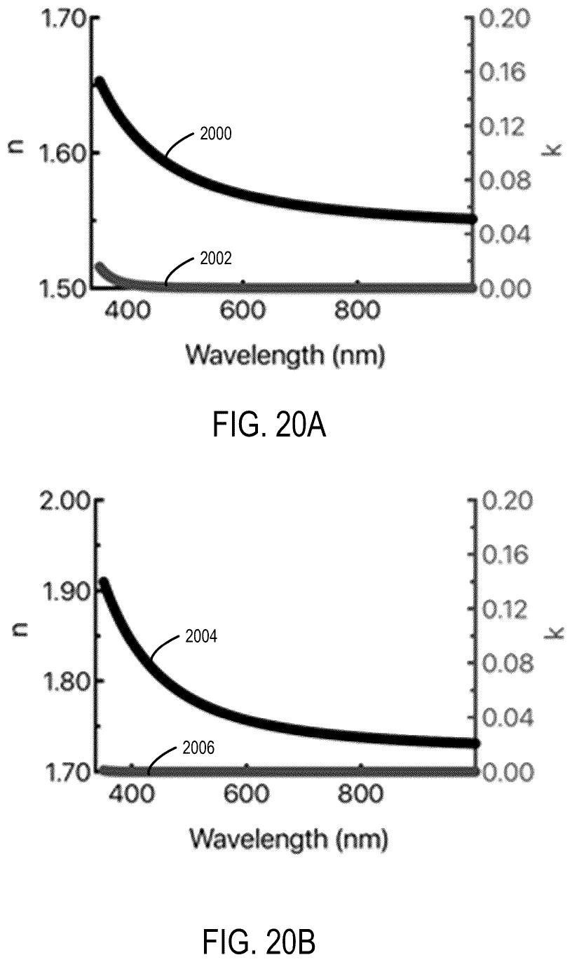

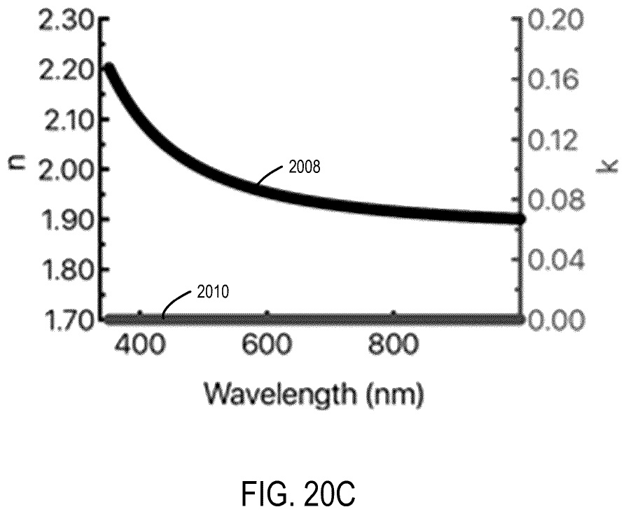

FIG. 20A shows a graph of refractive index 2000 and optical absorption coefficient 2002 for an example uncured SrₓTi_{y}Oₙ film deposited using an acid-stabilized liquid phase precursor solution. The film of FIG. 20A was deposited using a precursor formed by mixing 4 mL TiCl₃·3HCI (30%) (aq), 0.5 mL H₂O₂ (aq), (30%), and 0.75 g SrCl₂(s). The mixture was sonicated for five minutes. The solution was spin coated at 3000 RPM for 30 s. FIG. 20B shows a graph of refractive index 2004 and optical absorption coefficient 2006 for a SrO+TiO₂ film after performing UV light curing using a Novascan UV/O3 tool for 5 min. As can be seen, the refractive index rose upon UV curing across the visible spectrum compared to the uncured film of FIG. 20A. The UV-cured film of FIG. 20B has less optical absorbance in the lower wavelength range of the visible spectrum than the uncured film of FIG. 20A. FIG. 20C shows a graph of refractive index 2008 and optical absorption coefficient 2010 for a SrₓTi_{y}Oₙ film after annealing at 300 degrees Celsius for 10 minutes. As can be seen, the refractive index is higher than for the uncured and the UV cured films.

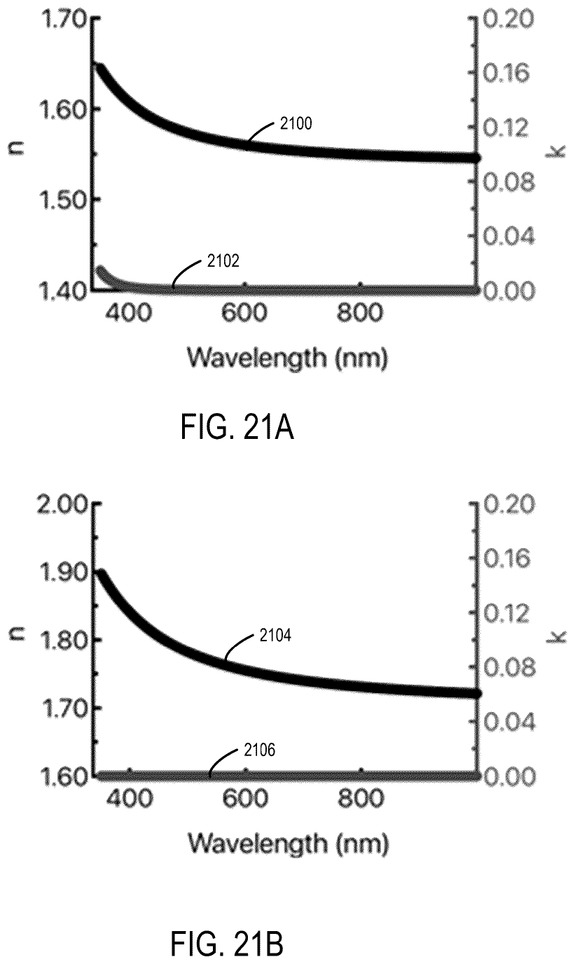

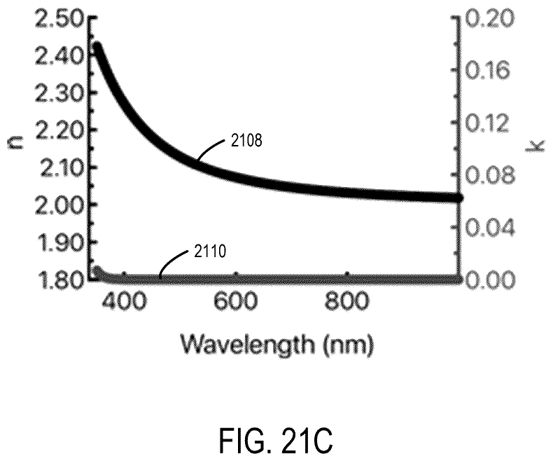

FIG. 21A shows a graph of refractive index 2100 and optical absorption coefficient 2102 for an example uncured YₓTi_{y}Oₙ film deposited using an acid-stabilized liquid phase precursor solution. The film of FIG. 21A was deposited using a precursor formed by (1) preparing a solution A by mixing 4 mL TiCl₃·3HCI (30%) (aq) and 0.5 mL H₂O₂ (aq) (30%); (2) preparing a solution B by mixing 0.3 g YCl₃(s)+1 mL HCl (aq)+0.5 mL H₂O₂ (aq) (30%); and (3) adding solution A to solution B and sonicating for 5 min. The solution was spin coated at 3000 RPM for 30 s. FIG. 21B shows a graph of refractive index 2104 and optical absorption coefficient 2106 for a YₓTi_{y}Oₙ film after performing UV light curing using a Novascan UV/O3 tool for 5 min. As can be seen, the refractive index rose upon UV curing across the visible spectrum compared to the uncured film of FIG. 21A. FIG. 21C shows a graph of refractive index 2108 and optical absorption coefficient 2110 for a YₓTi_{y}Oₙ film after annealing at 300 degrees Celsius for 10 minutes. As can be seen, the refractive index is higher than for the uncured and the UV cured films.

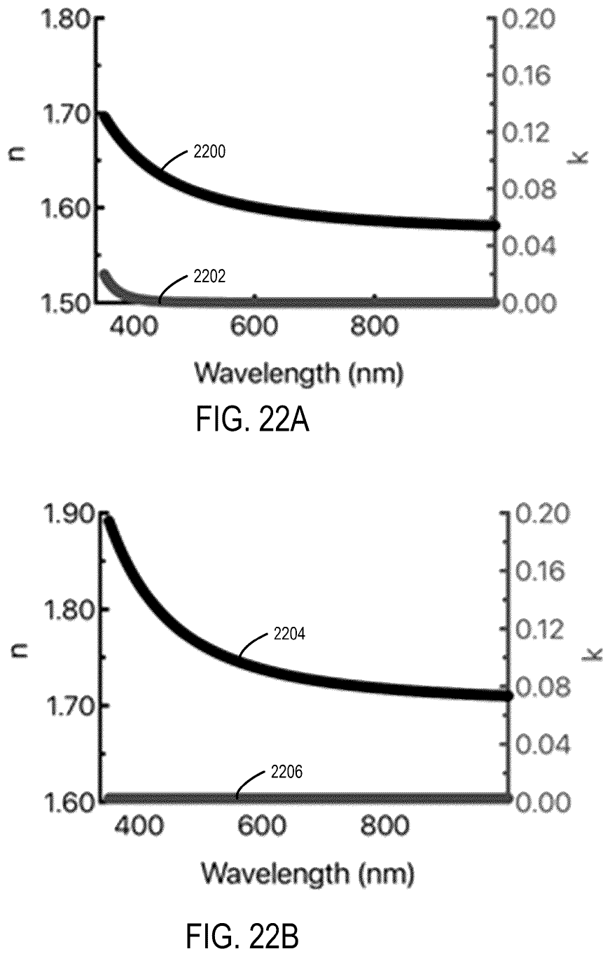

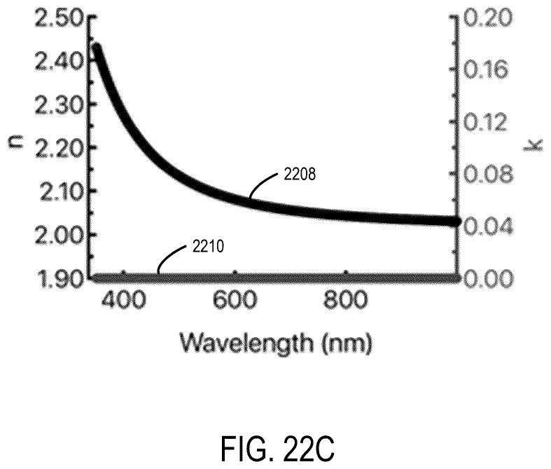

FIG. 22A shows a graph of refractive index 2200 and optical absorption coefficient 2202 for an example uncured NbₓTi_{y}Oₙ film deposited using an acid-stabilized liquid phase precursor solution. The film of FIG. 22A was deposited using a precursor formed by mixing 4 mL TiCl₃·3HCI (30%) (aq), 0.5 mL H₂O₂ (aq) (30%), and 4 mL [H₃Nb₆O₁₉]⁵⁻aq) (25%). The solution was spin coated at 3000 RPM for 30 s. FIG. 22B shows a graph of refractive index 2204 and optical absorption coefficient 2206 for a NbₓTi_{y}Oₙ film after performing UV light curing using a Novascan UV/O3 tool for 5 min. As can be seen, the refractive index rose upon UV curing across the visible spectrum compared to the uncured film of FIG. 22A. FIG. 22C shows a graph of refractive index 2208 and optical absorption coefficient 2210 for a NbₓTi_{y}Oₙ film after annealing at 300 degrees Celsius for 10 minutes. As can be seen, the refractive index is higher than for the uncured and the UV cured films.

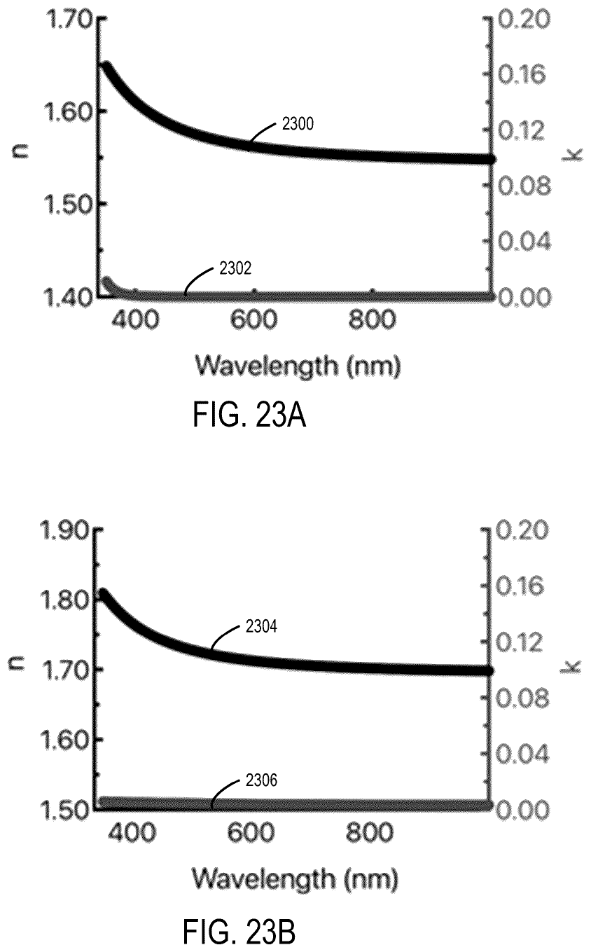

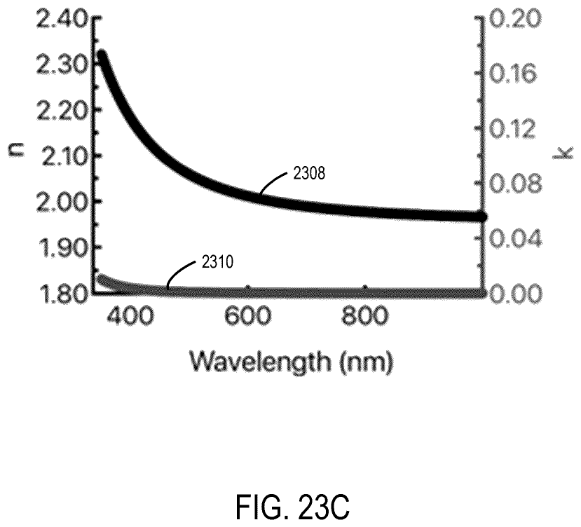

FIG. 23A shows a graph of refractive index 2300 and optical absorption coefficient 2302 for an example uncured SnₓTi_{y}Oₙ film deposited using an acid-stabilized liquid phase precursor solution. The film of FIG. 23A was deposited using a precursor prepared by (1) forming a solution A by mixing 4 mL TiCl₃·3HCI (30%) (aq) and 0.75 mL H₂O₂ (aq) (30%); (2) forming a solution B by mixing 0.6 g SnCl₄(s) and 1 mL HCl (aq); and adding solution A to B and sonicating for 5 min. The solution was spin coated at 3000 RPM for 30 s. FIG. 23B shows a graph of refractive index 2304 and optical absorption coefficient 2306 for a SnₓTi_{y}Oₙ film after performing UV light curing using a Novascan UV/O3 tool for 5 min. As can be seen, the refractive index rose upon UV curing across the visible spectrum compared to the uncured film of FIG. 23A. FIG. 23C shows a graph of refractive index 2308 and optical absorption coefficient 2310 for a SnₓTi_{y}Oₙ film after annealing at 300 degrees Celsius for 10 minutes. As can be seen, the refractive index is higher than for the uncured and the UV cured films.

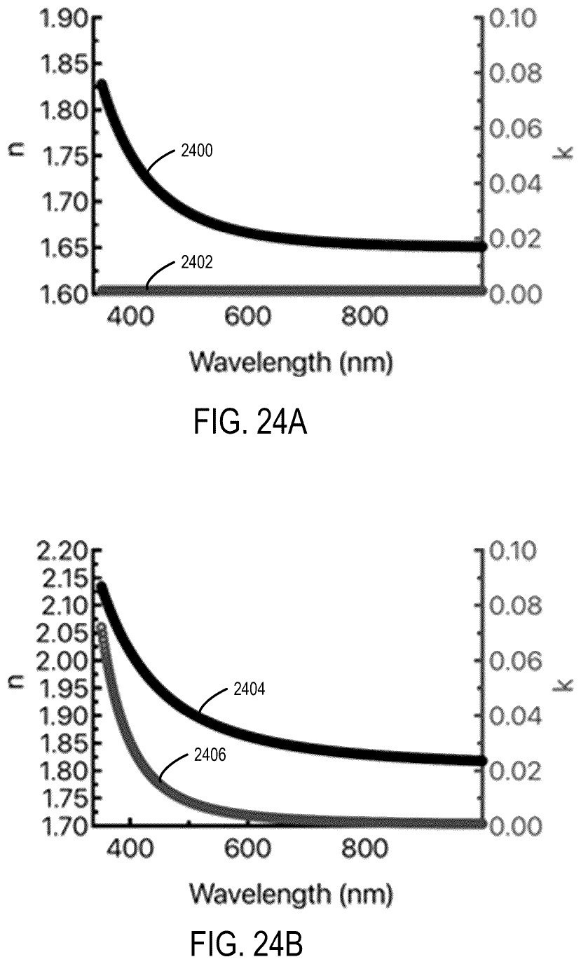

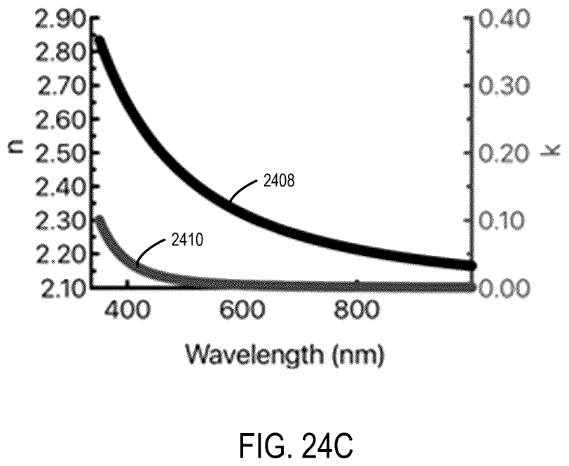

FIG. 24A shows a graph of refractive index 2400 and optical absorption coefficient 2402 for an example uncured BiₓTi_{y}Oₙ film deposited using an acid-stabilized liquid phase precursor solution. The film of FIG. 24A was deposited using a precursor prepared by (1) forming a solution A by mixing 4 mL TiCl₃·3HCI (30%) (aq) and 0.75 mL H₂O₂ (aq) (30%); (2) forming a solution B by mixing 2.43 g Bi(NO₃)₃.5H₂O (s), 1 mL HCl (aq), and 1 mL H₂O₂ (aq) (30%); and adding solution A to B and sonicating for 5 min. The solution was spin coated at 3000 RPM for 30 s. FIG. 24B shows a graph of refractive index 2404 and optical absorption coefficient 2406 for a BiₓTi_{y}Oₙ film after performing UV light curing using a Novascan UV/O3 tool for 5 min. As can be seen, the refractive index rose upon UV curing across the visible spectrum compared to the uncured film of FIG. 24A. FIG. 24C shows a graph of refractive index 2408 and optical absorption coefficient 2410 for a BiₓTi_{y}Oₙ film after annealing at 300 degrees Celsius for 10 minutes. As can be seen, the refractive index is higher than for the uncured and the UV cured films.

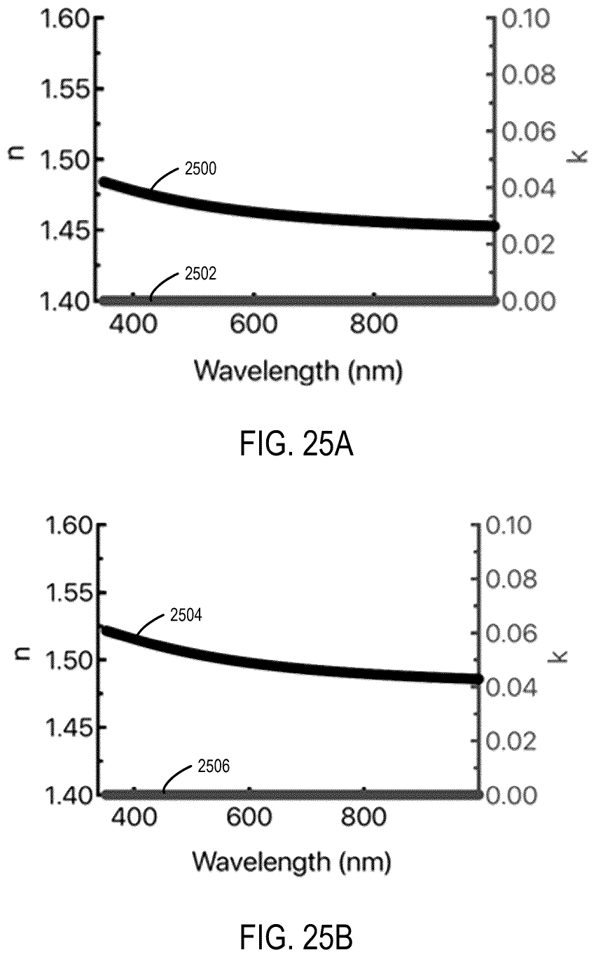

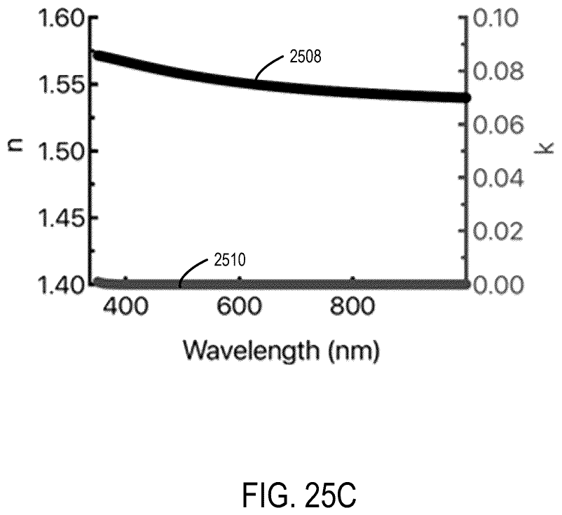

FIG. 25A shows a graph of refractive index 2500 and optical absorption coefficient 2502 for an example uncured Al₂O₃ film deposited using an acid-stabilized liquid phase precursor solution. The film of FIG. 25A was deposited using a precursor prepared by mixing 8 g Al(OH)₃ and 10 mL formic acid (aq). The solution was spin coated at 3000 RPM for 30 s. FIG. 25B shows a graph of refractive index 2504 and optical absorption coefficient 2506 for an Al₂O₃ film after performing UV light curing using a Novascan UV/O3 tool for 5 min. As can be seen, the refractive index rose upon UV curing across the visible spectrum compared to the uncured film of FIG. 25A. FIG. 25C shows a graph of refractive index 2508 and optical absorption coefficient 2510 for an Al₂O₃ film after annealing at 300 degrees Celsius for 10 minutes. As can be seen, the refractive index is higher than for the uncured and the UV cured films.

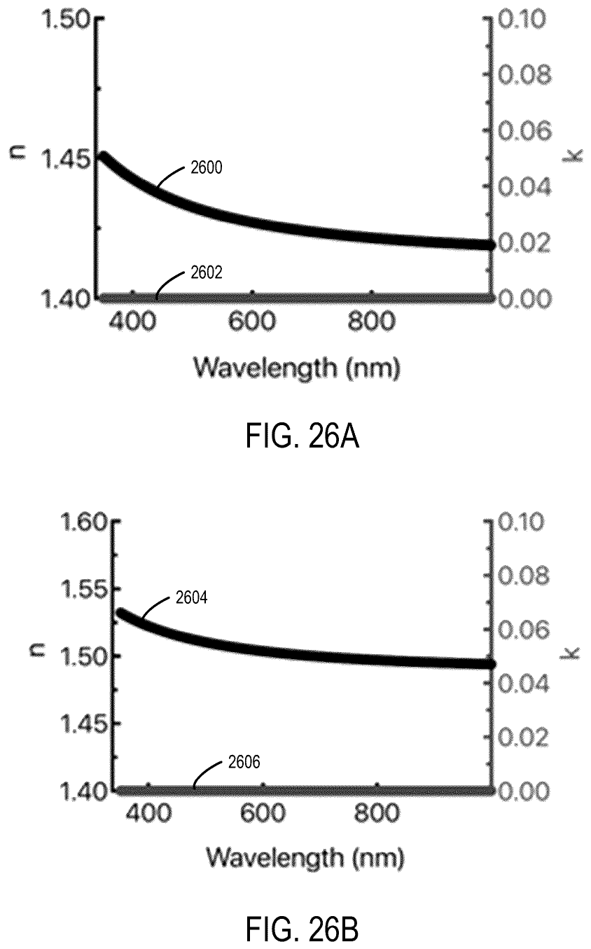

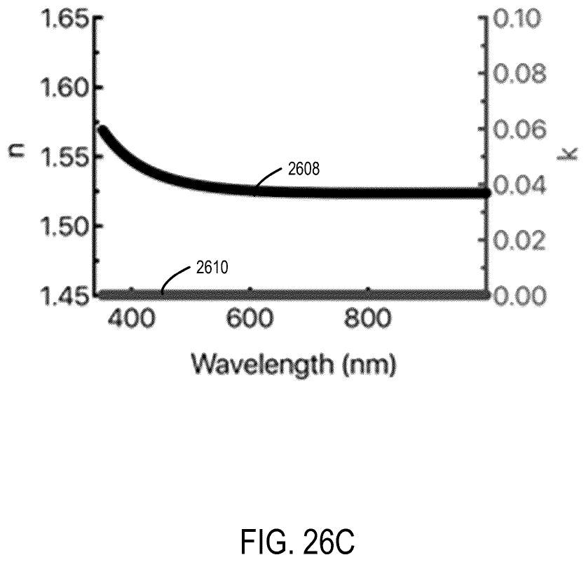

FIG. 26A shows a graph of refractive index 2600 and optical absorption coefficient 2602 for an example uncured LiₓAl_{y}Oₙ film deposited using an acid-stabilized liquid phase precursor solution. The film of FIG. 26A was deposited using a precursor prepared by mixing 2 g Al(OH)₃ and 2.5 mL formic acid (aq), and then adding 0.5 g of LiCl. The solution was spin coated at 3000 RPM for 30 s. FIG. 26B shows a graph of refractive index 2604 and optical absorption coefficient 2606 for an LiₓAl_{y}Oₙ film after performing UV light curing using a Novascan UV/O3 tool for 5 min. As can be seen, the refractive index rose upon UV curing across the visible spectrum compared to the uncured film of FIG. 26A. FIG. 26C shows a graph of refractive index 2608 and optical absorption coefficient 2610 for an LiₓAl_{y}Oₙ film after annealing at 300 degrees Celsius for 10 minutes. As can be seen, the refractive index is higher than for the uncured and the UV cured films.

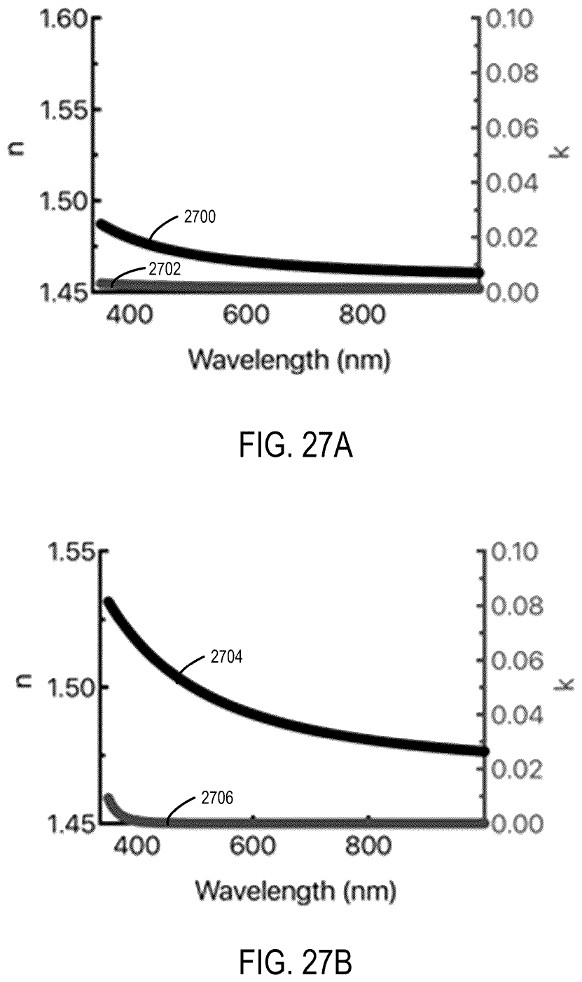

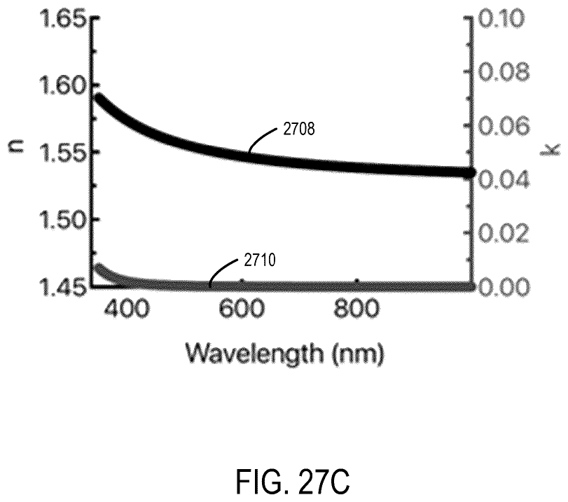

FIG. 27A shows a graph of refractive index 2700 and optical absorption coefficient 2702 for an example uncured SrₓAl_{y}Oₙ film deposited using an acid-stabilized liquid phase precursor solution. The film of FIG. 27A was deposited using a precursor prepared by mixing 2 g Al(OH)₃ and 2.5 mL formic acid (aq), and then adding 0.5 g of SrCl₂. The solution was spin coated at 3000 RPM for 30 s. FIG. 27B shows a graph of refractive index 2704 and optical absorption coefficient 2706 for an SrₓAl_{y}Oₙ film after performing UV light curing using a Novascan UV/O3 tool for 5 min. As can be seen, the refractive index rose upon UV curing across the visible spectrum compared to the uncured film of FIG. 27A. FIG. 27C shows a graph of refractive index 2708 and optical absorption coefficient 2710 for an SrₓAl_{y}Oₙ film after annealing at 300 degrees Celsius for 10 minutes. As can be seen, the refractive index is higher than for the uncured and the UV cured films.

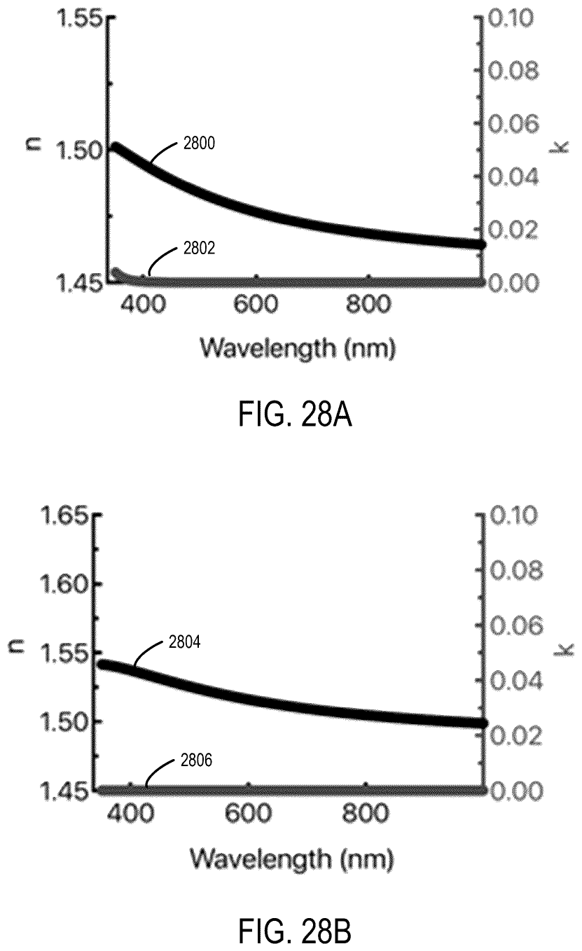

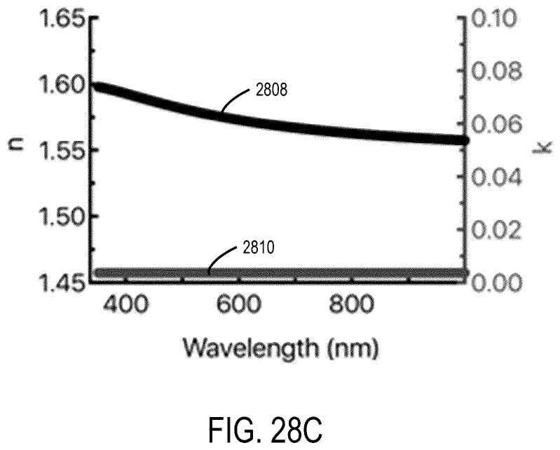

FIG. 28A shows a graph of refractive index 2800 and optical absorption coefficient 2802 for an example uncured YₓAl_{y}Oₙ film deposited using an acid-stabilized liquid phase precursor solution. The film of FIG. 28A was deposited using a precursor prepared by (1) preparing a solution A by mixing 2 g Al(OH)₃ and 2.5 mL formic acid (aq); (2) preparing a solution B by mixing 0.3 g YCl₃, 1 mL HCl and 0.5 mL H₂O₂ (aq) (30%); and (3) mixing solution A and solution B and sonicating for 5 minutes. The solution was spin coated at 3000 RPM for 30 s. FIG. 28B shows a graph of refractive index 2804 and optical absorption coefficient 2806 for an YₓAl_{y}Oₙ film after performing UV light curing using a Novascan UV/O3 tool for 5 min. As can be seen, the refractive index rose upon UV curing across the visible spectrum compared to the uncured film of FIG. 28A. FIG. 28C shows a graph of refractive index 2808 and optical absorption coefficient 2810 for an YₓAl_{y}Oₙ film after annealing at 300 degrees Celsius for 10 minutes. As can be seen, the refractive index is higher than for the uncured and the UV cured films.

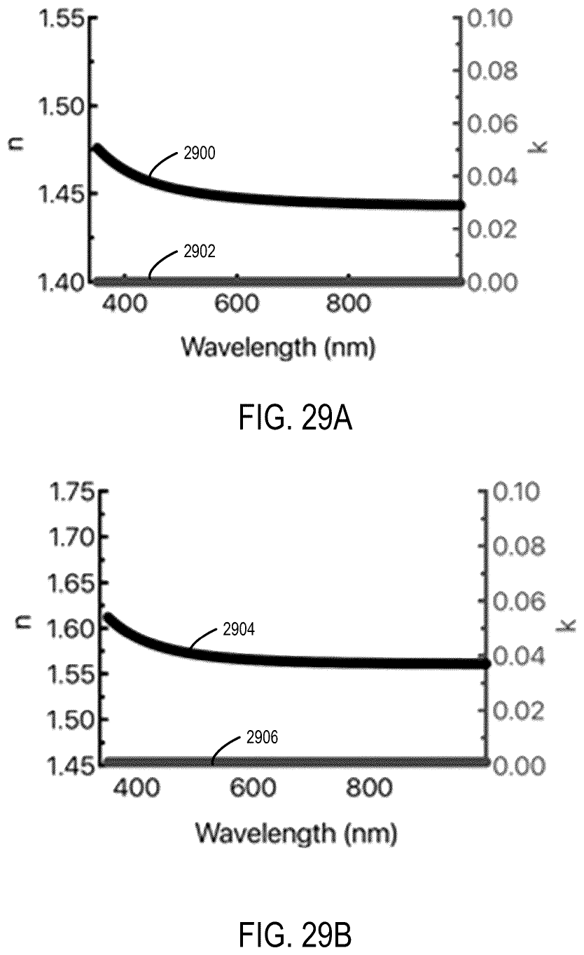

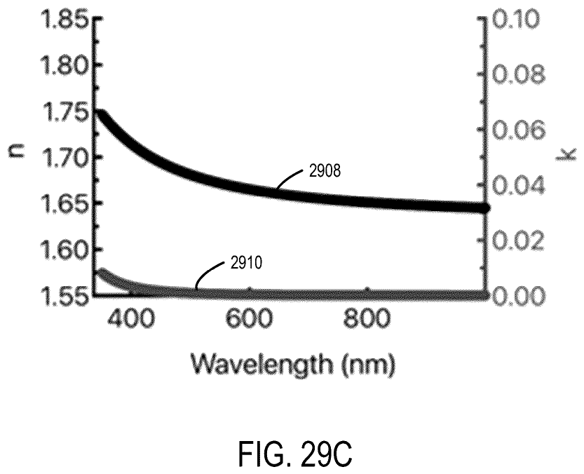

FIG. 29A shows a graph of refractive index 2900 and optical absorption coefficient 2902 for an example uncured NbₓAl_{y}Oₙ film deposited using an acid-stabilized liquid phase precursor solution. The film of FIG. 29A was deposited using a precursor prepared by (1) preparing a solution A by mixing 2 g Al(OH)₃ and 2.5 mL formic acid (aq); (2) preparing a solution B by mixing 0.3 g NbCl₅, 1 mL HCl and 0.5 mL H₂O₂ (aq) (30%); and (3) mixing solution A and solution B and sonicating for 5 minutes. The solution was spin coated at 3000 RPM for 30 s. FIG. 29B shows a graph of refractive index 2904 and optical absorption coefficient 2906 for an NbxAlyOn film after performing UV light curing using a Novascan UV/O3 tool for 5 min. As can be seen, the refractive index rose upon UV curing across the visible spectrum compared to the uncured film of FIG. 29A. FIG. 29C shows a graph of refractive index 2908 and optical absorption coefficient 2910 for an NbₓAl_{y}Oₙ film after annealing at 300 degrees Celsius for 10 minutes. As can be seen, the refractive index is higher than for the uncured and the UV cured films.

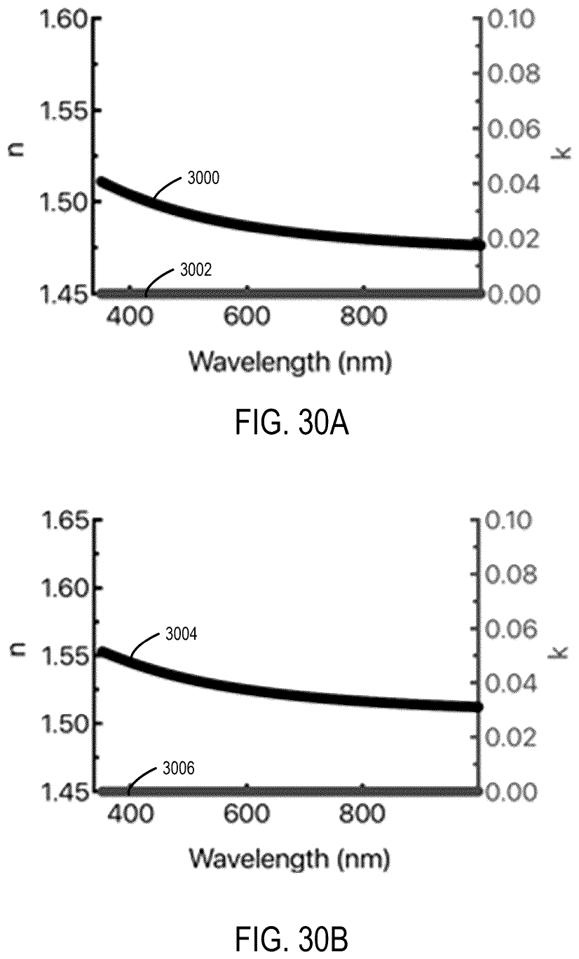

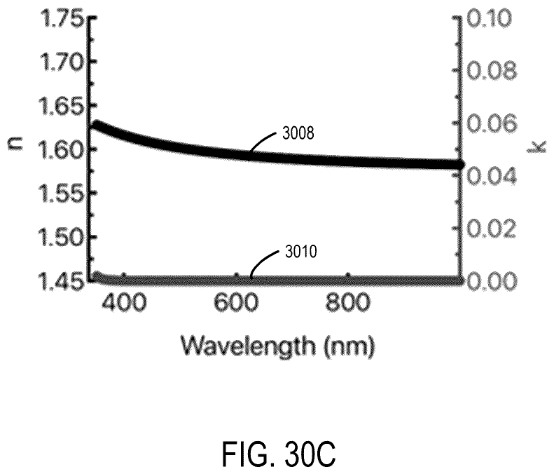

FIG. 30A shows a graph of refractive index 3000 and optical absorption coefficient 3002 for an example uncured SnₓAl_{y}Oₙ film deposited using an acid-stabilized liquid phase precursor solution. The film of FIG. 30A was deposited using a precursor prepared by (1) preparing a solution A by mixing 2 g Al(OH)₃ and 2.5 mL formic acid (aq); (2) preparing a solution B by mixing 0.3 g SnCl₄, 1 mL HCl and 0.5 mL H₂O₂ (aq) (30%); and (3) mixing solution A and solution B and sonicating for 5 minutes. The solution was spin coated at 3000 RPM for 30 s. FIG. 30B shows a graph of refractive index 3004 and optical absorption coefficient 3006 for an SnₓAl_{y}Oₙ film after performing UV light curing using a Novascan UV/O3 tool for 5 min. As can be seen, the refractive index rose upon UV curing across the visible spectrum compared to the uncured film of FIG. 30A. FIG. 30C shows a graph of refractive index 3008 and optical absorption coefficient 3010 for an SnₓAl_{y}Oₙ film after annealing at 300 degrees Celsius for 10 minutes. As can be seen, the refractive index is higher than for the uncured and the UV cured films.

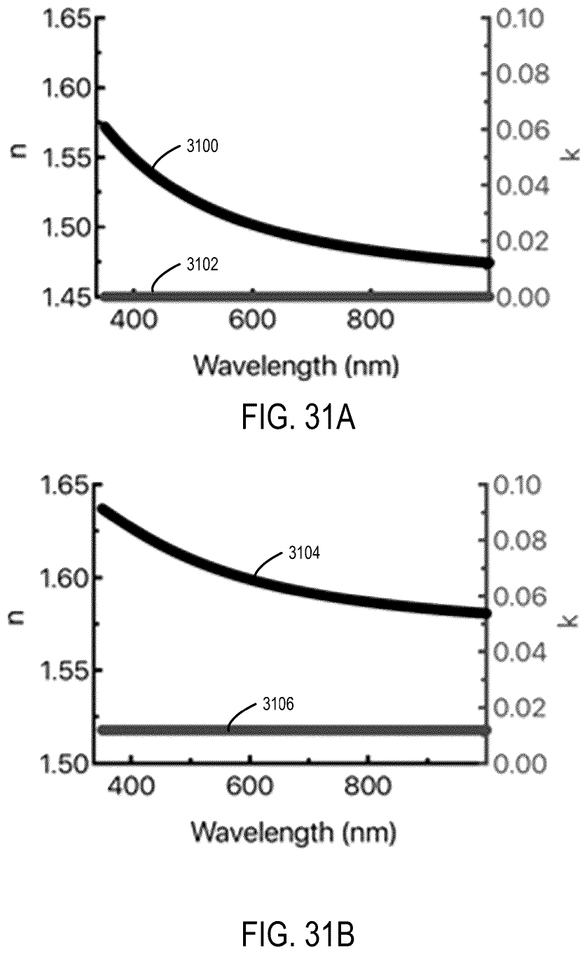

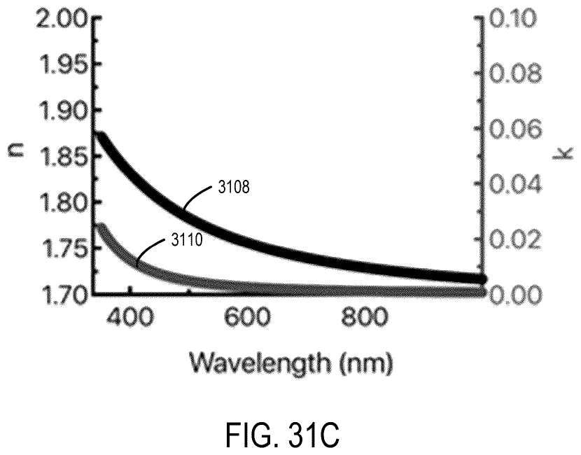

FIG. 31A shows a graph of refractive index 3100 and optical absorption coefficient 3102 for an example uncured BiₓAl_{y}Oₙ film deposited using an acid-stabilized liquid phase precursor solution. The film of FIG. 31A was deposited using a precursor prepared by (1) preparing a solution A by mixing 2 g Al(OH)₃ and 2.5 mL formic acid (aq); (2) preparing a solution B by mixing 0.5 g Bi(NO₃)₃(s), 1 mL HCl and 0.5 mL H₂O₂ (aq) (30%); and (3) mixing solution A and solution B and sonicating for 5 minutes. The solution was spin coated at 3000 RPM for 30 s. FIG. 31B shows a graph of refractive index 3104 and optical absorption coefficient 3106 for an BiₓAl_{y}Oₙ film after performing UV light curing using a Novascan UV/O3 tool for 5 min. As can be seen, the refractive index rose upon UV curing across the visible spectrum compared to the uncured film of FIG. 31A. FIG. 31C shows a graph of refractive index 3108 and optical absorption coefficient 3110 for an BiₓAl_{y}Oₙ film after annealing at 300 degrees Celsius for 10 minutes. As can be seen, the refractive index is higher than for the uncured and the UV cured films.

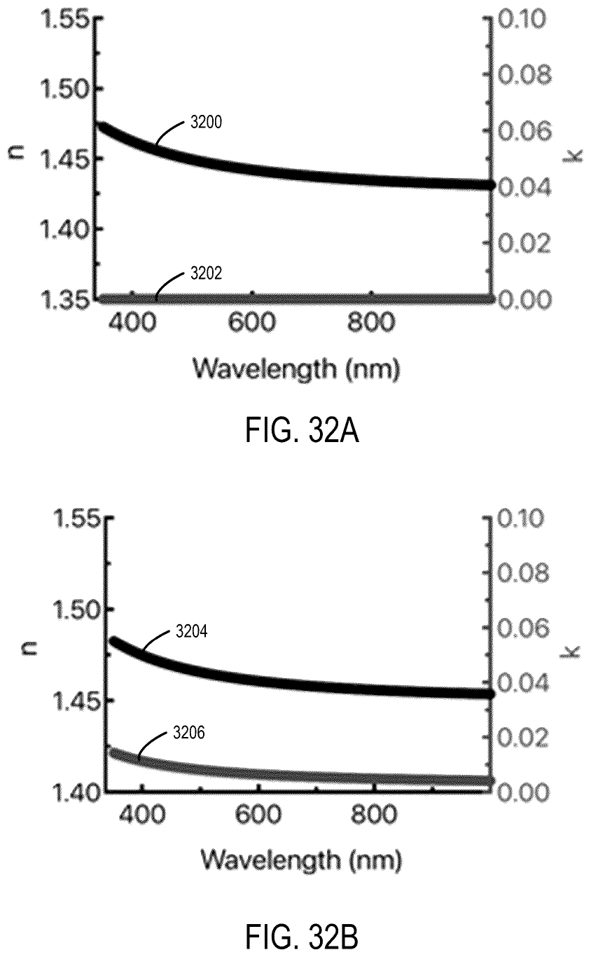

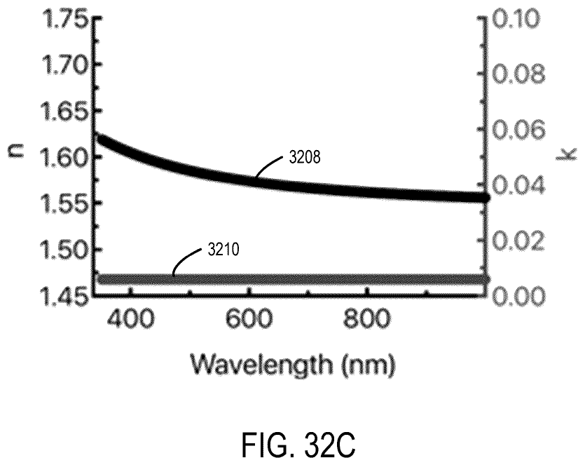

FIG. 32A shows a graph of refractive index 3200 and optical absorption coefficient 3202 for an example uncured LaₓAl_{y}Oₙ film deposited using an acid-stabilized liquid phase precursor solution. The film of FIG. 32A was deposited using a precursor prepared by mixing 2 g Al(OH)₃, 2.5 mL formic acid (aq), 0.5 g LaCl₃, and 0.5 mL H₂O₂ (aq) (30%). The solution was spin coated at 3000 RPM for 30 s. FIG. 32B shows a graph of refractive index 3204 and optical absorption coefficient 3206 for an LaₓAl_{y}Oₙ film after performing UV light curing using a Novascan UV/O3 tool for 5 min. As can be seen, the refractive index rose upon UV curing across the visible spectrum compared to the uncured film of FIG. 32A. FIG. 32C shows a graph of refractive index 3208 and optical absorption coefficient 3210 for an LaₓAl_{y}Oₙ film after annealing at 300 degrees Celsius for 10 minutes. As can be seen, the refractive index is higher than for the uncured and the UV cured films.

The examples above show that a variety of metal oxide films can be deposited from acid-stabilized precursor solutions. All of the above-described acid-stabilized precursors other than the LaₓAl_{y}Oₙ solution were shelf-stable for at least 2 weeks.

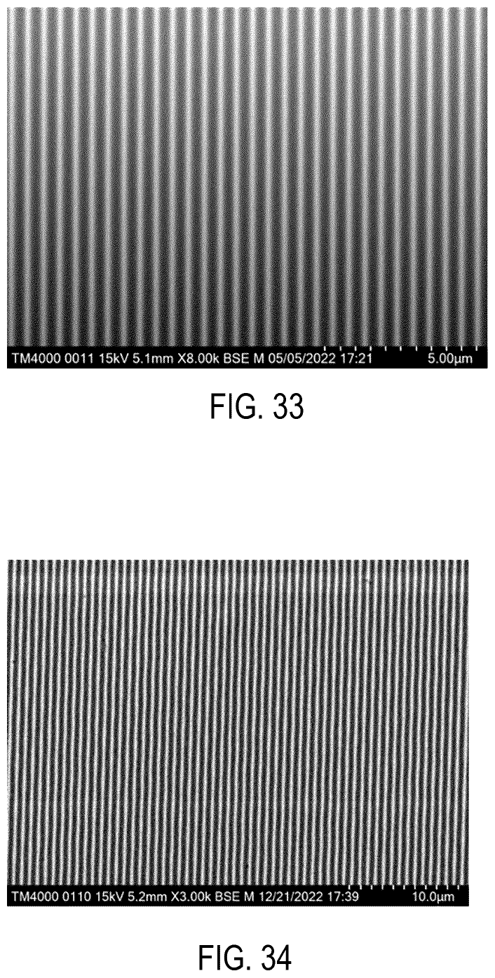

FIGS. 33 and 34 show images of TiO₂ films deposited using a TiO₂ precursor solution as disclosed above. The films were imprinted, exposed to UV light, and cured at 350 degrees Celsius. The refractive index was measured to be 2.35.

Films formed from precursor solutions according to the present disclosure can have a variety of uses. Regarding group 4 metal oxides, titanium dioxide (TiO₂) thin films have applications in diverse industries from optoelectronics to catalysis. Such films are also widely used as a coating in ceramics and glass to improve their mechanical and optical properties. TiO₂ enhances the strength, durability, and resistance to chemical corrosion in these materials. Additionally, TiO₂ coatings find applications in photovoltaics, self-cleaning surfaces, biomedical coatings, and energy storage devices (e.g. thin film lithium-ion batteries), showcasing their versatility and importance in various fields. Lastly, it has applications in optical materials including lenses, optical filters, and waveguides structures due to its high refractive index and transparency.

Zirconium dioxide (ZrO₂) has many useful properties, including high-temperature resistance, mechanical strength, and biocompatibility, which make it valuable in a wide range of applications. ZrO₂ thin films are utilized in medical implant coatings, oxygen sensors, thin film solid oxide fuel cells (TF-SOFCs), and as a component in high-performance optical coatings. In optical coatings, ZrO₂ is utilized for its high refractive index and transparency, allowing for precise light control and manipulation.

Hafnium oxide (HfO₂) has a high dielectric constant, high refractive index, and thermal stability, which make it valuable in electronics, optics, and energy storage. HfO₂ is used in semiconductor devices, such as transistors and thin film capacitors, for its excellent electrical insulating properties. It also finds applications in optical coatings, solar cells, thin film fuel cells, and protective coatings, showcasing its significance in advanced technologies.

Films of mixed metal oxides containing group 4 elements also have many uses. For example, lithium titanium oxide films are used in the field of energy storage. They are highly stable and safe and exhibit excellent electrochemical stability over a wide voltage range. This stability is helpful for applications that require long-lasting and reliable energy storage systems. They also possess an extremely fast charging and discharging capability makes them suitable for applications that demand high-power delivery, such as electric vehicles (EVs).

Strontium titanium oxide has a wide range of applications in fields such as electronics, photonics, energy storage, and materials science. It is employed as dielectric thin films in supercapacitors and electronic devices due to its high dielectric constant. It can also be utilized in various photonic and optical devices such as thin films for waveguides, integrated optics, and photonic circuits. Finally, it exhibits electro-optic and nonlinear optical properties, making it suitable for optical modulators and devices that manipulate light.

In electronics and optoelectronics, yttrium titanium oxide films can be utilized in transistors and thin film capacitors. Additionally, yttrium titanium oxide films show promise in energy conversion and thin film solar cell technologies enable efficient light-to-electricity conversion. Moreover, these films exhibit ferroelectric and multiferroic behavior, making them valuable in memory devices and spintronics. These oxide films also find applications in optical coatings, protective layers, and barrier films, leveraging their high-temperature stability, mechanical strength, and resistance to oxidation. Finally, they can be used for optical waveguides, photonic integrated circuits (PICs), nonlinear optics, electro-optic modulators, optical sensors, and optical coatings.

Titanium zirconium oxide films can find applications as transparent conductive oxides (TCOs) in devices such as touch screens, solar cells, and transparent electrodes, due to their high transparency and electrical conductivity. Furthermore, titanium zirconium oxide films are explored in energy storage and conversion applications, serving as thin film anode materials in thin-film lithium-ion batteries and catalyst supports in fuel cells. titanium zirconium oxide films demonstrate exceptional sensitivity to various gases, making them suitable for gas sensors used in healthcare (e.g. oxygen sensors). Additionally, the mechanical properties and corrosion resistance of titanium zirconium oxide films make them ideal for protective coatings, offering enhanced durability and surface protection.

Niobium titanium oxide films can be utilized as dielectric materials in thin film capacitors and electronic devices because of their high dielectric constant, low leakage current, and excellent thermal stability. They can be used as electrode materials in thin-film lithium-ion batteries. In the field of photonics, niobium titanium oxide films also can be used in optical coatings, waveguide manufacturing, antireflection coatings, and optical filters. Finally, these films are suitable for gas sensors used in biomedical applications due to their exceptional sensitivity to various gases.

Aluminum titanium oxide films offer a wide range of applications in microelectronics, optical coatings, corrosion protection, catalysis, and energy storage systems. In microelectronics, aluminum titanium oxide films find crucial applications as gate dielectrics in metal-oxide-semiconductor (MOS) devices. These films also exhibit remarkable properties for optical coatings. With their high refractive index, excellent optical transparency, and durability, they are well-suited for applications such as waveguide manufacturing, antireflection coatings, mirror coatings, and protective layers. Further, aluminum titanium oxide can be used as electrode materials in fuel cells and thin-film lithium-ion batteries.

Titanium tin oxide films have applications in optoelectronics, gas sensing, photocatalysts, and electrochromic devices. In optoelectronics, they can be used for designing transparent conductive electrodes for a wide range of optoelectronic devices, including liquid crystal displays (LCDs), touchscreens, and solar cells. In electrochromic devices, these films can be ideal for smart windows that can control the amount of sunlight and heat.

Bismuth titanium oxide finds application in various fields including piezoelectric devices, thin film capacitors, non-volatile memory, pyroelectric sensors, electrooptic devices, and multilayer ceramic capacitors (MLCCs). Its piezoelectric properties allow it to convert electrical energy into mechanical motion or vice versa and can be used for actuators, sensors, and transducers. The ferroelectric nature of bismuth titanate makes them good candidates in the production of high-energy-density thin film capacitors. It also exhibits pyroelectric properties, which makes it suitable for applications such as motion detection, infrared imaging, and thermal imaging cameras. Another important application of bismuth titanium oxide is in the field of electrochemical energy storage for use in thin-film lithium-ion batteries and supercapacitors.

Titanium lanthanum oxide films can be used in optoelectronic devices such as thin-film transistors (TFTs), photodetectors, and light-emitting diodes (LEDs). They also have shown promise in energy storage applications, particularly in the development of smaller supercapacitors and thin film lithium-ion batteries. Finally, due to their combination of high transparency and conductivity, these films can be utilized as transparent conductive coatings in applications like touchscreens, solar cells, and antistatic coatings.

Like other titanium oxide films, cerium titanium oxide has energy storage applications, specifically in thin film supercapacitors and thin film lithium-ion batteries. They are also used as electrolytes in thin film solid oxide fuel cells (TF-SOFCs). Titanium cerium oxide films can also be deposited as protective coatings to provide excellent corrosion resistance and protect the underlying material from environmental degradation.

Next regarding group 13 mixed metal oxides, lithium aluminum oxide films can have applications in semiconductor and optoelectronic devices, thin film lithium-ion batteries, and dielectric materials. They possess a wide bandgap, making them suitable for fabricating transparent conductive layers or as a component in heterostructures for device integration. They also exhibit good dielectric properties, including low dielectric loss and high breakdown strength. This makes them suitable for use as insulating layers in electronic devices, such as thin film capacitors, transistors, and memory devices. Finally, they can potentially be used as solid-state electrolytes in lithium-ion batteries.

Aluminum strontium oxide films have applications in solid-state lighting, dielectric materials, and thermal barrier coatings. They are used in solid-state lighting (SSL) as a phosphor host material and the dielectric layer. Aluminum strontium oxide can be utilized in dielectric materials such as thin film capacitors to improve performance and efficiency.

Yttrium Aluminum Oxide thin films exhibit excellent dielectric properties, high thermal stability, and good optical transparency, which make them suitable for various applications. They are used as dielectric layers in high-density capacitors such as dynamic random-access memory (DRAM) capacitors. These thin films are utilized in optics and waveguide structures due to their transparency in the visible and near-infrared regions. They can also be used as protective coatings to enhance the mechanical and chemical stability of underlying materials as a barrier against corrosion, oxidation, and wear. Finally, with specific doping, yttrium aluminum oxide thin films can exhibit ferroelectric properties, making them suitable for applications in non-volatile memory devices, such as ferroelectric random-access memory (FeRAM).

Niobate aluminate has been studied for various applications in fields such as optics, electronics, and catalysis. It exhibits excellent nonlinear optical properties, making it suitable for use in devices such as optical switches, frequency converters, and modulators. It can be used in telecommunications, optical computing, laser-based sensing, target detection, countermeasures, and other areas that rely on nonlinear optics. These films can also provide high dielectric constants, low dielectric losses, and good temperature stability, making them valuable for energy storage and signal processing applications.

Tin aluminum oxide films can be used in transparent conductive films, gas sensors, protective coatings, and photocatalysis. Sn—Al oxide films exhibit a combination of high transparency in the visible spectrum and electrical conductivity, making them promising candidates for transparent conductive films. They can also be utilized as protective coatings due to their hardness, corrosion resistance, and high-temperature stability.

Bi—Al oxide films can serve as dielectric materials in electronic devices. Bismuth-based materials, including Bi—Al oxide, have gained attention in the field of biomedical imaging because of their X-ray attenuation properties. Bi—Al oxide can also be incorporated into optical coatings, waveguides, or photonic devices. The unique optical properties of Bi—Al oxide can enable applications in areas such as telecommunications, optical sensors, and photonic integrated circuits.

Aluminum lanthanum oxide exhibits interesting properties and has various applications. It is often used as a dielectric material in electronic devices, such as thin film capacitors, due to its high dielectric constant and low electrical loss. It is also employed in the field of thin film solid oxide fuel cells (TF-SOFCs) as an electrolyte material due to its ionic conductivity. Additionally, aluminum lanthanum oxide finds applications in the fabrication of optical coatings, where its unique optical properties are utilized.

Next regarding mixed three-metal oxide films, lithium lanthanum titanium oxide films have various applications in solid state batteries and electronics. In solid-state batteries these films are being investigated as solid-state electrolytes in lithium-ion batteries. They exhibit high ionic conductivity and good stability, making them promising candidates for enhancing the safety and performance of next-generation solid-state batteries. They can also be used as thin-film capacitors in electronic devices, such as microelectronics and integrated circuits, for energy storage, filtering, and decoupling purposes.

Lithium bismuth titanium oxide films exhibit multiferroic behavior, meaning they simultaneously exhibit both ferroelectric and ferromagnetic properties which makes them suitable for Multiferroic Materials. They also showed potential for use in nonvolatile memory devices, such as ferroelectric random-access memory (FeRAM). Finally, due to their piezoelectric properties, these films can be utilized in energy-harvesting applications. They can convert mechanical vibrations into electrical energy, enabling the development of self-powered devices and sensors. For example, powering the street lighting with cars.

It will be understood that the configurations and methods described herein are provided by way of example, and that these examples are not to be considered in a limiting sense because numerous variations, extensions, and omissions are also envisaged. Any of the various acts of an above method may be performed in the sequence illustrated, in other sequences, in parallel, or omitted. The subject matter of the present disclosure includes all novel and non-obvious combinations and sub-combinations of the various configurations, methods, properties, and other features disclosed herein, as well as any and all equivalents thereof.

1. An aqueous precursor solution for forming a metal oxide film by liquid-phase deposition, the precursor solution comprising:
metal ions;
a photolyzable and/or pyrolyzable ligand; and
an acid.

2. The aqueous precursor solution of claim 1, wherein the metal ions comprise group 4 or group 13 ions.

3. The aqueous precursor solution of claim 2, wherein the titanium ions are a first metal species, and further comprising a second metal species.

4. The aqueous precursor solution of claim 1, wherein the metal ions comprise ions of one or more of Al, Ga, Bi, Sc, Cu, Al, Sc, V, Cr, Mn, Fe, Co, Ni, Zn, Y, Zr, Nb, Mo, In, Sn, Sb, Hf, Ta, W, Ir, Pt, La, Ce, Pr, Nd, Pm, Sm, Eu, Gd, Tb, Dy, Ho, Er, Tm, Yb, or Lu.

5. The aqueous precursor solution of claim 1, wherein the aqueous precursor solution comprises one or more group 4 or 13 ions and one or more other ions from group 1 and/or group 2 and/or group 3, and/or group 4, and/or group 5, and/or group 13 and/or group 14 and/or group 15 and/or F-block ions.

6. The aqueous precursor solution of claim 1, wherein the acid comprises one or more of hydrochloric acid, nitric acid, or sulfuric acid.

7. The aqueous precursor solution of claim 1, wherein the photolyzable and/or pyrolyzable ligand comprises one or more of a peroxide or a carboxylic acid.

8. The aqueous precursor solution of claim 7, wherein the photolyzable and/or pyrolyzable ligand comprises one or more of hydrogen peroxide, nitrate, or formic acid.

9. The aqueous precursor solution of claim 1, wherein the precursor solution comprises nanoparticles.

10. A method of forming a metal oxide film, the method comprising:
coating a substrate with an aqueous precursor solution comprising metal ions, a photolyzable and/or pyrolyzable ligand, and an acid to form a film; and
curing the film.

11. The method of claim 10, wherein curing the film comprises one or more of UV curing the film or annealing the film.

12. The method of claim 11, further comprising imprinting a pattern into the film before curing the film.

13. The method of claim 2, further comprising etching the film after curing the film to form a pattern in the film.

14. The method of claim 10, wherein coating the substrate with the aqueous precursor solution comprising metal ions comprises coating the substrate with an aqueous precursor solution comprising group 4 ions.

15. The method of claim 10, wherein the film comprises one or more of an optical light extraction or encapsulation layer for an organic light emitting diode (OLED) display device, an optical element in a near-eye device, or a waveguide.

16. The method of claim 10, wherein the film comprises a solid state electrolyte comprising titanium ions and lithium ions.

17. A method of forming an optical waveguide, the method comprising:
coating a substrate with an acid-stabilized aqueous precursor solution comprising metal ions, a photolyzable and/or pyrolyzable ligand, and an acid, to form a film on the substrate;
curing the film; and
patterning the film.

18. The method of claim 17, wherein the acid-stabilized aqueous precursor solution comprises ligand-bound metal ions and nanoparticles having a higher density than the ligand-bound metal ions.

19. The method of claim 1, wherein patterning the film comprises imprinting a pattern into the film before curing the film.

20. The method of claim 1, wherein patterning the film comprises etching the film.
